(19) United States
(12) Patent Application Publication
(10) Pub. No.: US 2009/0262361 A1
(43) Pub. Date: Oct. 22, 2009

(54) OPTICAL PROBE

(75) Inventors: Hiromichi Tanioka, Ashigarakami-gun (JP); Kazuyuki Takahashi, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: Terumo Kabushiki Kaisha, Tokyo (JP)

(21) Appl. No.: 12/492,985

(22) Filed: Jun. 26, 2009

Related U.S. Application Data
(63) Continuation of application No. PCT/JP2007/072194, filed on Nov. 15, 2007.

(30) Foreign Application Priority Data
Dec. 28, 2006 (JP) 2006-356019

(51) Int. Cl. G01B 11/24; G01B 9/02

(52) U.S. Cl. 356/479

(57) ABSTRACT

A catheter device for an optical coherence tomography apparatus is configured to enhance the resolution of the cross-sectional image in the azimuthal direction. The catheter device includes a drive shaft driven to rotate in a catheter sheath, an optical fiber in the drive shaft and driven to rotate with the drive shaft, and an optical component attached to a distal portion of the optical fiber. The catheter device emits light, transmitted in the optical fiber, into a body cavity through the optical component. A surface on the optical path of the optical component is a curved surface facing the drive shaft direction or the azimuthal direction to ensure that, when light emitted from the optical component is radiated into the body cavity via the catheter sheath, the difference between the diameter of the radiated light in the drive axis direction and the azimuthal direction is reduced.

This application is a continuation of International Application No. PCT/JP2007/072194 filed on Nov. 15, 2007, the entire content of which is incorporated herein by reference. This application is also based on and claims priority to Japanese Application No. 2006-356019 filed on Dec. 28, 2006, the entire content of which is incorporated herein by reference.

### TECHNICAL FIELD

The present invention generally relates to an optical probe. More specifically, the present invention pertains to an optical probe having useful application in an optical coherence tomography apparatus.

### BACKGROUND ART

Catheter type imaging diagnostic apparatuses have been used for diagnosis of arteriosclerosis, for pre-operation diagnosis in the case of intravascular treatment by use of a high-functional catheter such as a balloon catheter, a stent, etc. or for post-operation confirmation of the results of an operation.

An example of an imaging diagnostic apparatus is an intravascular ultrasound (IVUS) apparatus. Generally speaking, in an intravascular ultrasound apparatus, a probe with an ultrasonic transducer incorporated therein is operated under radial scanning in a blood vessel, and the reflected wave (ultrasonic echo) from living body tissue in the blood vessel is received by the same ultrasonic transducer. Thereafter, the reflected wave thus received is subjected to treatments such as amplification, detection, etc., so as to obtain a cross-sectional image of the blood vessel on the basis of the intensity of the ultrasonic echo produced.

To obtain a cross-sectional image with higher resolution, development of optical coherence tomography (OCT) apparatuses for performing imaging diagnosis by utilizing the coherence of light has recently been advanced. In the optical coherence tomography, reflected light from the surface and the inside of a living body tissue in a blood vessel is superposed on reference light obtained separately by spectral treatment of low-coherence light and matching of optical path length, so as to extract reflected light from a specified point in the depth direction of the living body tissue. The reflected light thus extracted is converted into an electrical signal, which in turn is converted into image information, to obtain a cross-sectional image of the blood vessel.

Furthermore, development of a wavelength sweep utilizing type optical coherence tomography (OFDI: Optical Frequency Domain Imaging) apparatus, which is an improved version of an optical coherence tomography apparatus, has recently been under way. In the wavelength sweep utilizing type optical coherence tomography (OFDI), the wavelength of coherent light incident on an intravascular tissue is varied continuously, whereby reflected light from each point in the depth direction of the tissue is extracted based on the difference in frequency component. Based on the reflected light thus extracted, a cross-sectional image of the blood vessel is obtained. The wavelength sweep type optical coherence tomography (OFDI) has the advantage that the need for a movable section for continuously varying the optical path length of reference light can be eliminated, as compared with the ordinary optical coherence tomography (OCT).

In the so-called optical coherence tomography apparatuses such as OCT and OFDI apparatuses, an optical fiber is used to transmit coherent light. The optical fiber, which corresponds to the electric transmission line in the intravascular ultrasound apparatus, is inserted in a drive shaft for transmitting a rotational driving force, and a part is fixed to the drive shaft.

In the optical coherence tomography apparatus, the part corresponding to the ultrasonic transducer in the intravascular ultrasound apparatus is an optical component such as a spacer, a rod lens, a prism, etc. formed at a distal portion of the optical fiber. By virtue of the optical component, the light diverged from the optical fiber is converged and, further, is deflected in a direction substantially perpendicular to the drive shaft.

Optical coherence tomography apparatus generally use a single mode optical fiber for communication use. Fused quartz is used as the material for the core and the clad of the optical fiber. The above-mentioned coherent light is propagated to the distal portion of the optical fiber while being reflected in the optical fiber, utilizing the difference in refractive index between the core and the clad of the optical fiber.

A component part for diverging light, called a spacer, is connected to the distal portion of the optical fiber. In the spacer, the coherent light is diverged into a conical form at an NA (numerical aperture: a numerical value determining the maximum acceptance angle of light which can enter the optical fiber) determined by the optical fiber (the coherent light thus diverged is hereinafter referred to as “light beam”).

The light beam is converged through a rod lens connected to the distal side of the spacer, and is deflected in a perpendicular direction by a prism connected to the distal side of the rod lens. The light beam thus proceeds in a direction substantially perpendicular to the drive shaft and the sheath (catheter sheath), where it is emitted through the sheath into the body cavity as a convergent light.

Here, in an optical probe for an optical coherence tomography apparatus having a sheath (catheter sheath) and a drive shaft, the sheath refracts the light beam deflected into the perpendicular direction by the prism, due to the material of which the sheath is made.

In general, light propagated through two media is refracted to a greater extent at the boundary surface (interface) between the media as the difference between the refractive indices of the media is greater. Snell's law represents a relational expression about light refraction. According to Snell's law, in the case where light is incident on the boundary surface between media A and B having different refractive indices, if the refractive indices of media A and media B are n1 and n2 respectively, the relation between the incidence angle θ1 and θ2 is expressed by the following formula (Equation 1)

n₁ sin θ₁=n₂ sin θ₂ [Equation 1]

In the optical probe of an optical coherence tomography apparatus, it is preferable that the medium inside the sheath is a low-viscosity material, for high-speed rotation of the drive shaft. Therefore, normally, air at atmospheric pressure is used as the medium in the sheath.

Assuming that the medium inside the sheath is air and the material of the sheath is polyethylene, which is a general polymeric material, the fact that the refractive index of air is 1.0 and the refractive index of polyethylene is 1.54 results in a large difference in refractive index between the two materials, and so the light beam at the boundary surface between the sheath and air is deflected to a significant extent.

Further, due to the geometric shape (hollow cylindrical shape) of the sheath, the sheath has a concave lens effect on the light beam deflected into the perpendicular direction by the prism.

As a result, the light beam having passed through the sheath has an asymmetric shape in the direction of the drive axis of the drive shaft (hereinafter referred to as the “drive axis direction”) and the direction of azimuthal angle around the drive axis in the plane orthogonal to the drive axis direction (hereinafter referred to as the “azimuthal direction”). Since the refractive index of the sheath is higher than the refractive index of air, the light beam is refracted at the boundary surface between the sheath and air, wherein the light beam is converged in the drive axis direction because the sheath has a rectilinear shape along the drive axis direction but it is diverged in the azimuthal direction due to the above-mentioned concave lens effect because the sheath has a circular shape along the azimuthal direction.

In practice, when an optical construction involves the waist size of the light beam in air medium being 0.03 mm in the case of the distance from the output of the prism to the converging part of the light beam (working distance) being 2.0 mm and a light beam tracking simulation is carried out assuming that the medium inside the sheath is air and the medium in the body cavity outside the sheath is water, the light beam is spread in the azimuthal direction of the sheath to 0.42 mm at a position spaced by 2.0 mm from the surface of the output surface.

In addition, when the sheath and the drive shaft are actually produced on a trial basis and the spreading (diverging) of light in air and in water is confirmed, the shape of the light beam is substantially circular in air, but the shape of the light beam in water is an elliptic shape in which the light beam is spread more in the azimuthal direction than in the drive axis direction.

Such a phenomenon influences the resolution in the azimuthal direction of the sectional image obtained. In order to obtain a cross-sectional image with a higher resolution, it is desirable to make the shape of the converged spot of the light beam as close to a true circle as possible and to make the waist size of the light beam as small as possible.

Normally, in the optical coherence tomography apparatus used for diagnosis of the inside of a blood vessel and the inside of a body cavity, the drive shaft in which the optical fiber is inserted is disposed inside the sheath, and when the drive shaft is rotated one revolution the optical fiber is also rotated one revolution.

Specifically, the cross-sectional image of the inside of a body cavity is obtained through signal processing as to the intensity distribution of the reflected light in the azimuthal direction, for an amount of data corresponding to the number of scan lines during one revolution of the drive shaft. Therefore, as to the azimuthal direction, the resolution is enhanced as the number of scan lines increases.

However, in the case where the light beam has been undesirably spread in the azimuthal direction due to the above-mentioned concave lens effect of the sheath, no matter how much the number of scan lines is increased, the resolution in the azimuthal direction cannot be enhanced. In the case where the half-value width of the reflected light intensity is sufficiently greater than the interval of the scan lines, the resolution of the cross-sectional image cannot be enhanced even if the number of the scan lines is increased. In view of this, it is desirable to remove, as much as possible, the influence of the concave lens effect of the sheath.

The present invention has been made in consideration of the above-mentioned problems. Accordingly, it is an object of the present invention to enhance the resolution in the azimuthal direction of a sectional image obtained, in an optical probe for an optical coherence tomography apparatus having a sheath and a drive shaft.

### SUMMARY

An optical probe disclosed here includes an optical probe which includes a drive shaft having an optical fiber driven to rotate in a sheath inserted in a body cavity, and an optical component attached to a distal portion of the optical fiber, and is operative to emit light, transmitted in the optical fiber, toward a living body tissue in the body cavity from the optical component. When the light transmitted in the optical fiber and emitted from the optical component is radiated to the living body tissue through the sheath, the optical component corrects the light on an optical path of the light so that a difference in coefficient of convergence or coefficient of divergence is generated between a drive axis direction of the drive shaft and an azimuthal direction around the drive axis direction of the drive shaft and that the difference between the diameter of the radiated light in the drive axis direction and the diameter of the radiated light in the azimuthal direction is thereby reduced. The optical probe disclosed here desirably enhances the resolution in the azimuthal direction of the cross-sectional image obtained.

The optical probe includes a drive shaft positionable in a sheath which is insertable in a body cavity, with the drive shaft being comprised of an optical fiber and an optical component attached to a distal portion of the optical fiber. The optical component comprises an inclined surface formed as a curved surface configured to reflect a light beam which has reached a distal portion of the optical fiber, and an outgoing surface formed as a convex surface facing outwards in an azimuthal direction around the drive axis direction, The inclined surface and the outgoing surface are configured to correct the light beam so that a difference in coefficient of convergence or coefficient of divergence is generated between the drive axis direction and the azimuthal direction and so that a difference between the diameter of the radiated light in the drive axis direction and the diameter of the radiated light in the azimuthal direction is thereby reduced.

According tom another aspect, an optical coherence tomography apparatus comprises a catheter device comprised of a drive shaft, a scanner and pull-back unit operatively connected to the catheter device to effect radial scanning of the drive shaft, and a controller operatively connected to the scanner and pull-back unit to control operation of the scanner and pull-back unit. The drive shaft includes an optical fiber rotatably positioned in a sheath configured to be inserted in a body cavity, and an optical component attached to the distal portion of the optical fiber and operative to emit light, transmitted in the optical fiber, through the sheath as radiated light directed toward living body tissue in the body cavity, Additionally, the optical component comprises means for correcting the light, which is transmitted in the optical fiber on an optical path, so that a difference in coefficient of convergence or coefficient of divergence is generated between a drive axis direction of the drive shaft and an azimuthal direction around the drive axis direction and so that a difference between the diameter of the radiated light in the drive axis direction and the diameter of the radiated light in the azimuthal direction is thereby reduced.

### BRIEF DESCRIPTION OF THE DRAWINGS

Other features and advantages of the optical probe disclosed here will become more apparent from the following detailed description considered with reference to the accompanying drawing figures in which like elements and features are designated by like reference numerals. A brief description of the accompanying drawing figures is set forth below.

FIG. 1 illustrates an optical coherence tomography apparatus including a catheter device according to one disclosed embodiment.

FIG. 2 schematically illustrates features associates with the optical coherence tomography apparatus.

FIG. 3 is a longitudinal cross-sectional view of a distal part of a drive shaft at the distal portion of the catheter device.

FIG. 4 is a longitudinal cross-sectional view similar to FIG. 3 schematically illustrating ray trajectories where a light beam is guided into an optical fiber.

FIG. 5 is a view of the distal portion of the catheter device as viewed from the distal end side, schematically showing ray trajectories of the light beam.

FIG. 6 illustrates a first optical component according to one embodiment.

FIG. 7 illustrates schematically aspects of the first optical component according to the first embodiment.

FIG. 8 illustrates parts of the first optical component according to the first embodiment.

FIG. 9 is a perspective view illustrating in a three-dimensional manner ray trajectories in the case where a light beam guided into an optical fiber is radiated to a living body tissue through a catheter sheath.

FIG. 10 illustrates the ray trajectories in an optical component having a prism in which the reflecting surface is a planar surface.

FIG. 11 illustrates aspects of a first optical component according to a second disclosed embodiment.

FIG. 12 illustrates parts of the second embodiment of the first optical component.

FIG. 13 illustrates parts of the first optical component according to the second embodiment.

FIG. 14 is a perspective view three-dimensionally showing ray trajectories in the case where a light beam guided into an optical fiber is radiated to a living body tissue through a catheter sheath.

FIG. 15 is a cross-sectional view, viewed from the side (longitudinal cross-sectional view), of a distal part of the drive shaft at a distal portion of the catheter device.

FIG. 16 illustrates schematically ray trajectories in the case where a light beam is guided into the optical fiber.

FIG. 17 is a distal end side view of the distal portion of the catheter device schematically showing ray trajectories of the light beam.

FIG. 18A illustrates part of a second optical component according to a third embodiment disclosed here, and FIG. 18B illustrates the configuration of the inclined surface of a ball lens (deflector) forming a part of the second optical component.

FIG. 19 illustrates parts of the second optical component according to the third embodiment.

FIG. 20 illustrates parts of the second optical component according to the third embodiment.

FIG. 21 illustrates parts of the second optical component according to the third embodiment.

FIG. 22 is a perspective view three-dimensionally illustrating ray trajectories in the case where a light beam guided into an optical fiber is radiated to a living body tissue through a catheter sheath.

FIG. 23 illustrates ray trajectories in a second optical component having a ball lens according to related art.

FIG. 24A illustrates aspects of a second optical component according to a fourth embodiment disclosed here, and FIG. 24B illustrates the configuration of the inclined surface of a ball lens (deflector) forming a part of the second optical component.

FIG. 25 illustrates parts of the second optical component according to the fourth embodiment.

FIG. 26 illustrates parts of the second optical component according to the fourth embodiment.

FIG. 27 illustrates parts of the second optical component according to the fourth embodiment.

FIG. 28 is a perspective view three-dimensionally illustrating ray trajectories in the case where a light beam guided into an optical fiber is radiated to a living body tissue through a catheter sheath.

FIG. 29 illustrates aspects of a second component of a catheter device according to a fifth embodiment disclosed here.

FIG. 30 illustrates parts of the second component of the catheter device according to the fifth embodiment.

FIG. 31 illustrates parts of the second component of the catheter device according to the fifth embodiment.

FIG. 32 illustrates parts of the second component of the catheter device according to the fifth embodiment.

FIG. 33 is a perspective view three-dimensionally illustrating ray trajectories in the case where a light beam guided into an optical fiber is radiated to a living body tissue through a catheter sheath.

### DETAILED DESCRIPTION

The embodiments of the optical component disclosed here will be described based on the kind of optical component constituting the distal portion of a catheter device which is a working mode of the optical probe.

Specifically, the following description will be made in divisions corresponding respectively to a case where an optical component including a spacer for diverging light at the distal end of an optical fiber, a rod lens for converging the diverged light beam, and a prism for deflecting the converged light beam in a perpendicular direction (this assembly will be referred to as a “first optical component”) is used as the optical component, another case where an optical component including a spacer for diverging light at the distal end of an optical fiber, an inclined surface for deflecting the diverged light beam into a perpendicular direction, and a ball lens for converging the deflected light beam (this assembly will be referred to as “second optical component”) is used as the optical component, and a further case where an optical component including a spacer which diverges light at the distal end of an optical fiber and has an inclined surface for deflecting the diverged light beam into a perpendicular direction (this assembly will be referred to as “third optical component”) is used as the optical component.

The first optical component will be described in first and second embodiments, the second optical component will be described in third and fourth embodiments, and the third optical component will be described in a fifth embodiment.

In addition, while the disclosure here, including the disclosed embodiments, will be discussed in the context of being applied to an optical coherence tomography (OCT) apparatus, the disclosure naturally is applicable also to a wavelength sweep utilizing type optical coherence tomography (OFDI) apparatus.

### First Embodiment

### 1. Configuration of Optical Coherence Tomography Apparatus

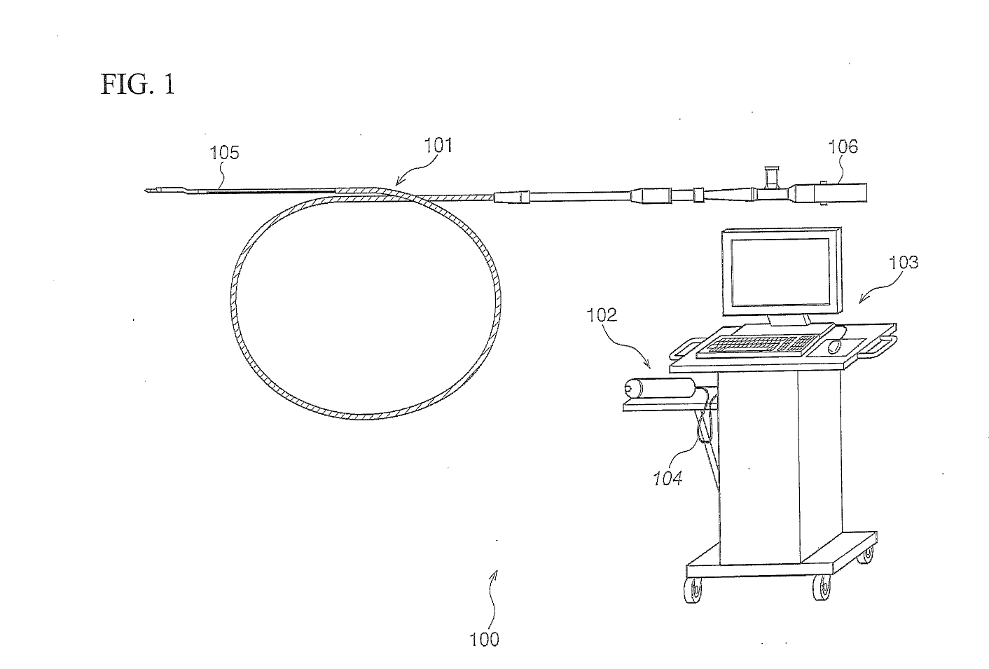

FIG. 1 illustrates the overall appearance and configuration of an optical coherence tomography apparatus 100 disclosed here including a catheter device according to a first embodiment disclosed here.

As shown in FIG. 1, the optical coherence tomography apparatus 100 includes a catheter device 101, a scanner and pull-pack unit or section 102, and an operation controller 103. The scanner and pull-back section 102 and the operation controller 103 are connected to each other by a signal cable 104.

The catheter device 101 is inserted directly into a blood vessel, and measures the condition in the blood vessel by use of reflected light of coherent light emitted via an optical component. The scanner and pull-back section 102 is connected to a connector 106 of the catheter device 101, and effects radial scanning of a drive shaft 105 inside the catheter device 101.

The operation controller 103 is configured to permit the input of various kinds of set points in performing intravascular optical coherence imaging diagnosis, and to process data obtained by measurement, and to display the processed data as a cross-sectional image. Thus, the controller 103 constitutes means for permitting input of data such as set points necessary to perform intravascular optical coherence imaging diagnosis, means for processing data obtained by measurement, and means for displaying the processed data as a cross-sectional image

### 2. Operational Configuration of Optical Coherence Tomography Apparatus

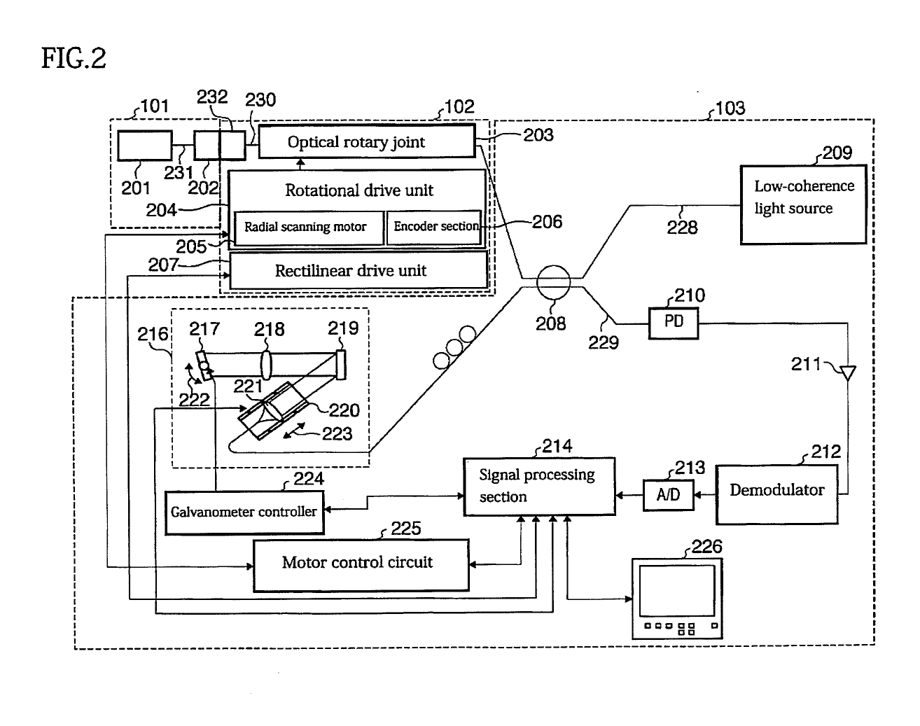

FIG. 2 illustrates the operational configuration of the optical coherence tomography apparatus 100 shown in FIG. 1.

A low-coherence light source 209, such as an ultrahigh-luminance light emitting diode, outputs low-coherence light which has a wavelength of about 1310 nm and which shows coherence only in a short distance (length) range such that the coherence length is from several micron to several tens of micrometers.

Therefore, when the light branches into two beams and the two beams are again superposed on each other, the light is detected as coherent light in the case where the difference between the two optical path lengths from the branching point to the superposing point is a short distance (length) range of about 17 micron, and the light is not detected as coherent light in the case where the difference between the optical path lengths is greater than the just-mentioned range.

The light from the low-coherence light source 209 is incident on one end of a first single mode fiber 228, and is transmitted toward the distal end face side. The first single mode fiber 228 is optically coupled to a second single mode fiber 229 at an optical coupler section 208. Therefore, the light is transmitted while being branched into two beams at the optical coupler section 208.

An optical rotary joint 203 is provided on the distal side of the optical coupler section 208 of the first single mode fiber 228. The optical rotary joint 203 connects a non-rotating section and a rotating section to each other, and transmits light.

Further, an optical connector 202 in the catheter device 101 is detachably connected to an adapter 232 at the distal end of a third single mode fiber 230 in the optical rotary joint 203. This helps ensure that the light from the low-coherence light source 209 is transmitted into a fourth single mode fiber 231 which is connected to the optical component 201 and which can be driven to rotate.

The light thus transmitted is radiated from the distal end side of the optical component 201 toward the side of a living body tissue in a body cavity while undergoing radial scanning. Then, part of the reflected light scattered by the surface or the inside of the living body tissue is picked up by the optical component 201, and returns through the reverse optical path to the side of the first single mode fiber 228. Part of the returning light is guided to the second single mode fiber 229 side by the optical coupler section 208, to be incident on a photodetector (for example, a photodiode 210) via one end of the second single mode fiber 229. The rotating section side of the optical rotary joint 203 is driven to rotate by a radial scanning motor 205 of a rotational drive unit 204. In addition, the rotational speed of the radial scanning motor 205 is detected by an encoder section 206. Furthermore, the optical rotary joint 203 has a rectilinear drive unit 207, and restricts the movement (movement in the drive axis direction) of the catheter device 101 in the insertion direction (the distal direction in the body cavity and the opposite direction), based on an instruction from a signal processing section 214. The movement in the drive axis direction is realized by operation of a rectilinear driving motor 215, based on a control signal from the signal processing section 214.

In addition, an optical path length variable mechanism 216 for varying the optical path length for reference light is provided on the distal side of the optical coupler section 208 of the second single mode fiber 229.

The optical path length variable mechanism 216 includes or constitutes a first optical path length varying means for varying at a relatively high speed the optical path length corresponding to an examination range in the depth direction of the living body tissue, and second optical path length varying means for absorbing the dispersions of optical path length due to individual differences among the apparatuses.

Opposite to the distal end of the second single mode fiber 229, a grating 219 is disposed in the state of being intermediated by a collimator lens 221 which is mounted onto a uniaxial stage together with the distal end and which is movable in the directions of the illustrated arrows 223. A galvanometer mirror 217 capable of turning by a minute angle is mounted as the first optical path length varying means, via a lens 218 corresponding to the grating 219 (diffraction grating). The galvanometer mirror 217 is rotated at a relatively high speed in the directions of the illustrated arrows 222 by a galvanometer controller 224.

The galvanometer mirror 217 is operative to reflect light by a mirror of a galvanometer, and functions as a reference mirror. It is so configured that when an AC driving signal is applied to the galvanometer, the mirror attached to a movable portion thereof is rotated at a high speed.

In other words, when the driving signal is impressed on the galvanometer by the galvanometer controller 224 and the mirror is rotated at a high speed in the direction of the illustrated arrow 222 by the driving signal, the optical path length for the reference light is varied at a high speed by an optical path length amount corresponding to the examination range in the depth direction of the living body tissue.

On the other hand, the uniaxial stage 220 forms the second optical path length varying means. Further, the uniaxial stage 220 also serves as an adjusting means for adjusting an offset.

The light of which the optical path length has been varied by the optical path length variable mechanism 216 is superposed with the light leaking from the side of the first single mode fiber 228 at the optical coupler section 208 provided in the course of the second single mode fiber 229, and the resultant light is received by the photodiode 210.

The light received by the photodiode 210 undergoes photoelectric conversion, and the resulting electric signal is amplified by an amplifier 211, before being inputted to a demodulator 212. In the demodulator 212, a demodulation processing for extracting only the signal portion of the interfered light is performed, and an output from the demodulator 212 is inputted to an analog-to-digital converter 213.

In the analog to digital converter 213, the interfered light signal is sampled in a 200-point amount, and digital data (interfered light data) in an amount corresponding to one line is generated. The sampling frequency is a value obtained by dividing the time for one scan of the optical path length by 200.

The line-basis interfered light data generated in the analog-to-digital converter 213 is inputted to the signal processing section 214. In the signal processing section 214, the interfered light data in the depth direction is converted into a video signal, whereby sectional images at each position in the blood vessel are formed, and the sectional images are outputted to an LCD monitor 226 at a predetermined frame rate.

The signal processing section 214 is connected to a motor control circuit 225, and controls the rotational driving of the radial scanning motor 205.

In addition, the signal processing section 214 is connected to the galvanometer controller 224 for controlling the scanning of the reference mirror (galvanometer mirror) over the optical path length, the galvanometer controller 224 outputs a driving signal to the signal processing section 214, and the motor control circuit 225 acts for synchronization with the galvanometer controller 224, based on the driving signal.

### 3. General Configuration of First Optical Component and Light Beam Ray Trajectories

The general configuration of the first optical component in the catheter device according to this embodiment and the ray trajectories in the process up to the emission of the light beam through the first optical component will be described below.

### 3.1 General Configuration of First Optical Component

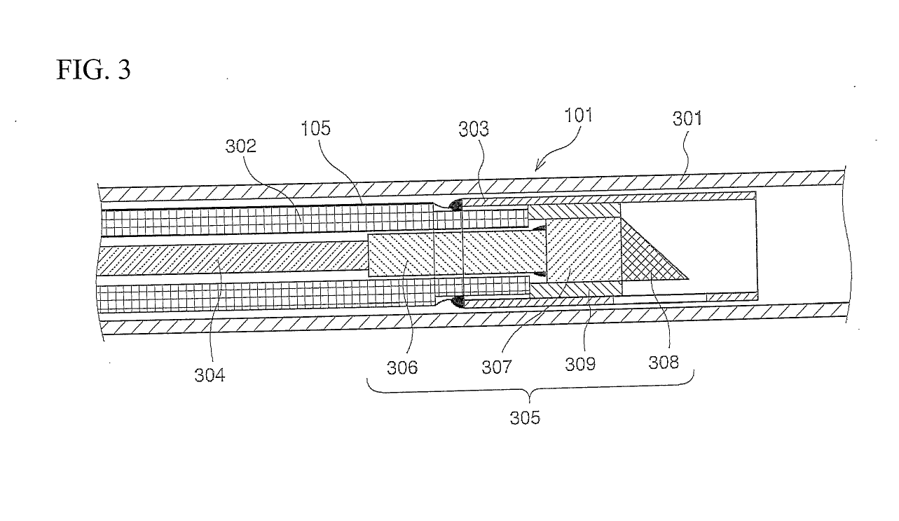

FIG. 3 illustrates the distal part of the drive shaft 105 at a distal portion of the catheter device 101. As shown in FIG. 3, the distal portion of the catheter device 101 has a configuration in which the drive shaft 105 is positioned in the catheter sheath 301.

The drive shaft 105 includes a coil shaft 302 of a multilayer contiguous-wound coil structure, and a housing 303 fixed to the distal end side of the coil shaft 302. The fourth single mode fiber 231 (hereinafter referred to as “optical fiber 304”) is positioned in the coil shaft 302, and a first optical component 305 for diverging and converging a light beam and deflecting the light beam into a perpendicular direction (inclusive of substantially perpendicular directions) is attached to a distal portion of the optical fiber 304. The first optical component 305 is comprised of a spacer 306, a SELFOC lens 307, and a prism (deflector) 308.

The distal part of the drive shaft 105 is fitted with a radiopaque marker 309 for ensuring that the position of the distal part of the drive shaft 105 can be confirmed under radioscopic observation.

The attaching of the first optical component 305 can be carried out by adhesion with a highly handleable adhesive such as a UV-curing adhesive, or by an optical fiber splicing method conducted using an optical fiber splicing machine.

### 3.2 Ray Trajectories

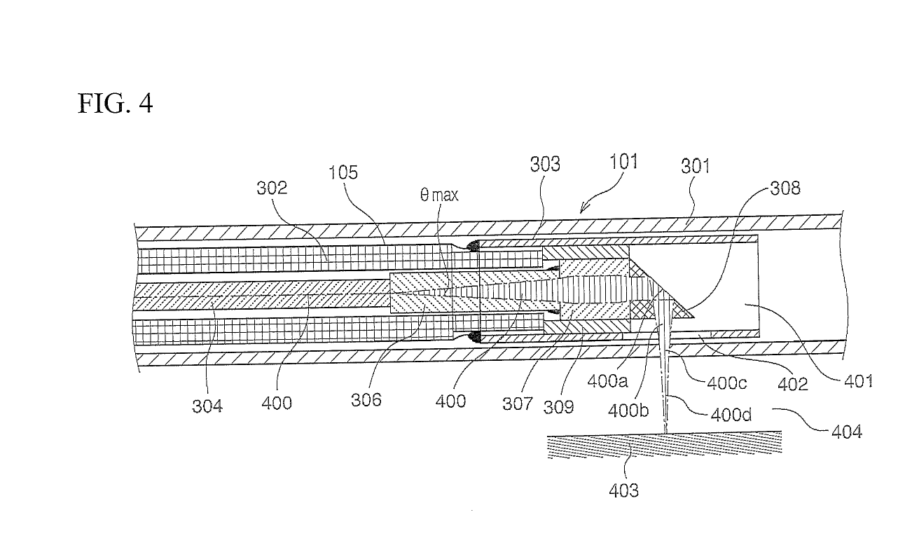

FIG. 4 illustrates schematically the ray trajectories in the case where the light beam is transmitted in the optical fiber 304 in FIG. 3. The optical fiber 304 is comprised of a core which is a central part having a high refractive index, and a clad (cladding) which surrounds the core and which is lower in refractive index than the core by around 1%. A light beam 400 is transmitted while undergoing total reflection at the boundary surface between the core portion and the clad portion.

The optical beam having reached the distal portion of the optical fiber 304 is diverged in the spacer 306 connected adjacently to the distal portion. If the divergence (spreading) angle of the light beam in this instance is θ max, the refractive index of the core is nil, and the refractive index of the clad is n2, the following relational expression (Equation 2) is established among the convergence angle θ max, the refractive index n1 of the core, and the refractive index n2 of the clad. The convergence angle θ max is referred to also as maximum acceptance angle or NA (numerical aperture).

θmax=n₁\sqrt{2(n₁−n₂)/n₁} [Equation 2]

The light beam 400 diverged in the spacer 306 is refracted in the SELFOC lens 307 connected adjacently to the spacer 306 so that the light beam is a converged light beam. A SELFOC lens is a special rod lens in which the refractive index varies in a parabolic form as a function of the radius, and which has such a property that the light beam incident on the front surface thereof takes a sinusoidal optical path along the rod lens.

In view of this, the length of the SELFOC lens is optimized based on the lens pitch (the period of the sinusoidal optical path) which is a parameter intrinsic of the SELFOC lens, whereby it is made possible to converge the light beam.

The converged light beam 400a exiting or going out of the SELFOC lens 307 is deflected into a substantially perpendicular direction by the prism (deflector) 308. Then, the deflected light beam is refracted at the boundary surface between the prism 308 and a medium (air) 401 to result in a light beam 400b which passes through an opening 402 in the housing 303.

Further, the light beam 400b having passed through the opening 402 is refracted at the boundary surface between the medium (air) 401 and the catheter sheath 301 as a light beam 400c. Furthermore, the light beam 400c is refracted at the boundary surface between the catheter sheath 301 and a medium (physiological saline used to displace blood) 404 so that a light beam 400d results which passes through the medium (the physiological saline used to displace blood) 404, and is radiated to the living body tissue 403 of a blood vessel or the like.

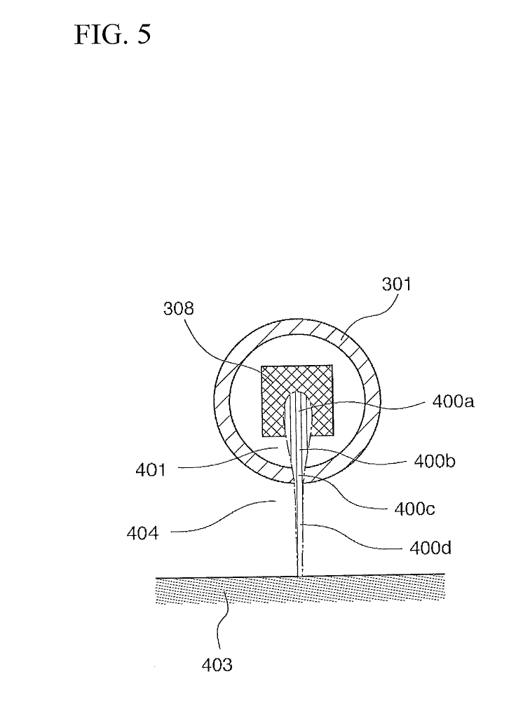

FIG. 5 illustrates the distal portion of the catheter device 101 as viewed from the distal end side, schematically showing the ray trajectories of the light beam. In FIG. 5, the light beam 400a propagated while being converged in the prism 308 is largely diffracted at the boundary surface between the prism 308 and air 401, which is a medium possessing a considerably lower refractive index than the prism 308, to result in the converged light beam 400b.

Thereafter, the light beam 400b is refracted at the boundary surface between the air 401 and the catheter sheath 301, which is a medium possessing a higher refractive index than the air 401, to result in the light beam 400c. The light beam 400c is slightly refracted at the boundary surface between the catheter sheath 301 and the physiological saline 404, which is a medium placed outside the catheter sheath, to result in the light beam 400d having a somewhat reduced NA, and the light beam 400d is radiated to the living body tissue 403 of a blood vessel or the like.

### 4. Configuration of First Optical Component

The description which follows describes in more detail aspects of the first optical component 305 having the above-mentioned configuration.

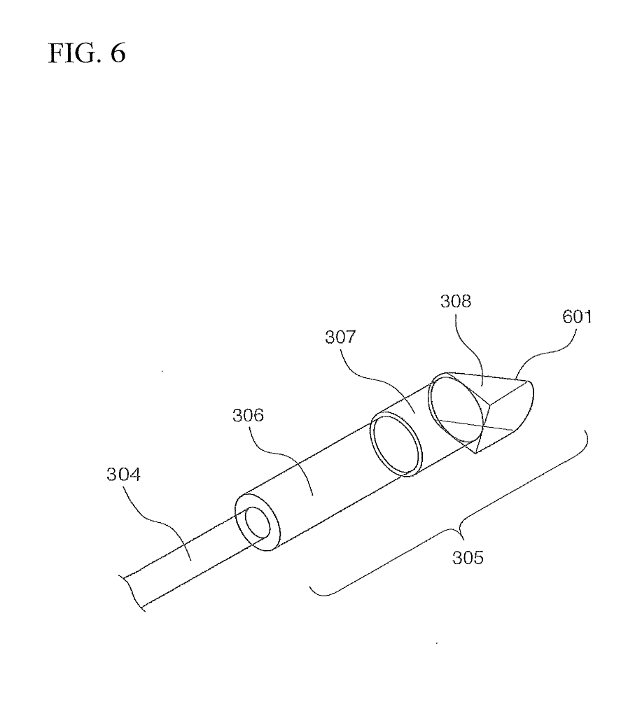

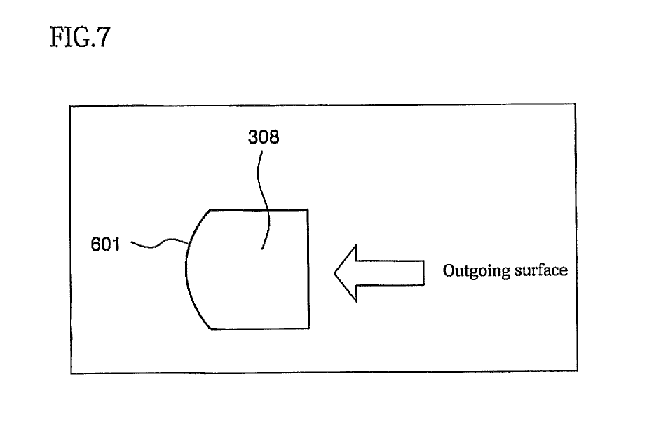

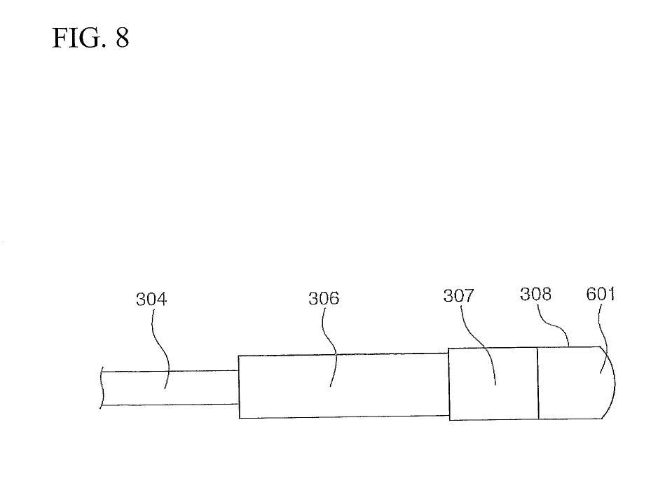

FIGS. 6-8 illustrate parts of the first optical component 305 in which FIG. 6 is a perspective view of the first optical component 305, FIG. 7 is a plan view of a distal portion of the optical fiber 304 as viewed from the distal end side, and FIG. 8 is a plan view of the optical fiber 304 as viewed from the upper side.

The first optical component 305 includes the prism 308 possessing a reflecting or deflecting surface 601 configured to be a convex surface, in the shape of a side surface of a cylinder, facing outwards in an azimuthal direction perpendicular to the axial direction of the optical fiber (this azimuthal direction will hereinafter be referred to simply as “azimuthal direction”). This helps ensure that the light beam 400a reflected on the reflecting surface 601 of the prism 308 becomes a light beam converged further in the azimuthal direction.

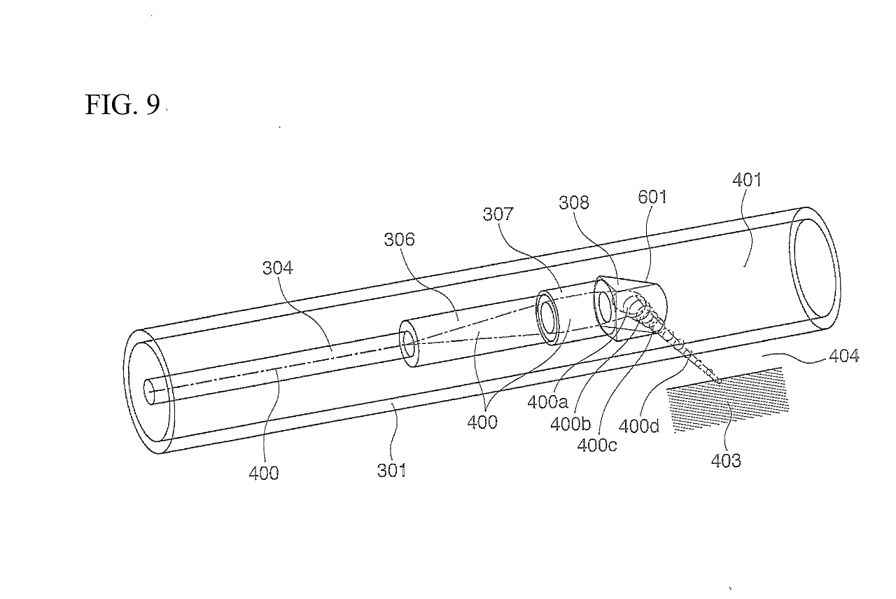

The configuration of the first optical component 305 is described below in more detail with reference to FIG. 9 which illustrates, in a partly transmissive perspective view, the ray trajectories where the light beam 400 guided into the optical fiber 304 is radiated to the living body tissue 403 through the catheter sheath 301 in FIG. 6.

As illustrated, the light beam 400 emitted from the end portion of the optical fiber 304 is diverged by the spacer 306 connected (directly connected) to the end portion of the optical fiber, is then converged in the azimuthal direction and the drive axis direction by the SELFOC lens 307 connected (directly connected) to the spacer 306, and is thereafter totally reflected by the reflecting surface 601, formed as a convex surface (the inner or inwardly facing reflecting surface is formed as a concave mirror or is a concave mirrored surface), of the prism 308.

In this case, due to the action of the reflecting surface 601 formed as a convex surface (the inner or inwardly facing reflecting surface is formed as a concave mirror or is a concave mirrored surface), the light beam 400a in the prism 308 is converged further in the azimuthal direction of the catheter sheath 301, as compared with the case of a reflecting surface formed as a flat surface. Specifically, comparing the phenomenon in the axial (drive axis) direction of the optical fiber with the phenomenon in the azimuthal direction perpendicular to the drive axis direction, the light beam 400a is converged at a relatively higher coefficient of convergence in the azimuthal direction. As a result, the sectional shape of the light beam is corrected to be an elliptical shape with a major diameter in the drive axis direction.

The light beam 400b exiting (going) out of the prism 308 is refracted at the boundary surface between the prism 400b and the medium (air) 401 present inside the catheter sheath 301, is converged in the state of having an NA enlarged in the azimuthal direction, and is propagated in the air present as the medium (air) 401 inside the catheter sheath 301 while keeping the elliptic sectional shape.

Upon being incident on the catheter sheath 301, the light beam 400b becomes the light beam 400c, which is so compensated (corrected) as to have an NA reduced in the azimuthal direction by the concave lens effect of the catheter sheath 301.

Further, upon being incident on the medium (physiological saline) 404 present outside the catheter sheath 301 from the catheter sheath 301, the light beam 400c becomes the light beam 400d, which has an NA reduced by the refraction at the boundary surface between the catheter sheath 301 and the medium 404. As a result, the NA in the azimuthal direction of the catheter sheath 301 approaches the NA in the drive axis direction (the difference between the respective NA values in both direction is reduced), so that the cross-sectional shape of the light beam 400d is a circular shape which is axisymmetrical (inclusive of a substantially axisymmetric circular cross-sectional shape in which the shape of the light beam is not precisely axisymmetric (e.g., due to minor variations associated with manufacturing tolerances for instance), but nevertheless produces substantially the same result/function as a light beam having a circular cross-sectional shape which is axisymmetric). By virtue of this, the beam waist size is reduced, making it possible to enhance the resolution in the azimuthal direction of the sectional image.

Specifically, the first optical component 305 (the reflecting surface 601) preliminarily compensates for that change in the balance between the NA in the azimuthal direction of the light beam 400b and the NA in the drive axis direction which is caused by the catheter sheath 301, and, as a result, the difference between both the NA values is reduced (the NA values become approximately equal). When the light transmitted in the optical fiber 304 is emitted from the optical component 305 for being radiated toward the living body tissue through the sheath 301, the optical component 305, including the reflecting surface 601, provides means for correcting the light on an optical path of the light so that a difference in coefficient of convergence or coefficient of divergence is generated between the drive axis direction of the drive shaft and the azimuthal direction around the drive axis direction of the drive shaft so that the difference between the diameter of the radiated light in the drive axis direction and the diameter of the radiated light in the azimuthal direction is thereby reduced (i.e., the cross-sectional shape of the light beam 400d is a circular shape which is axisymmetrical as discussed above).

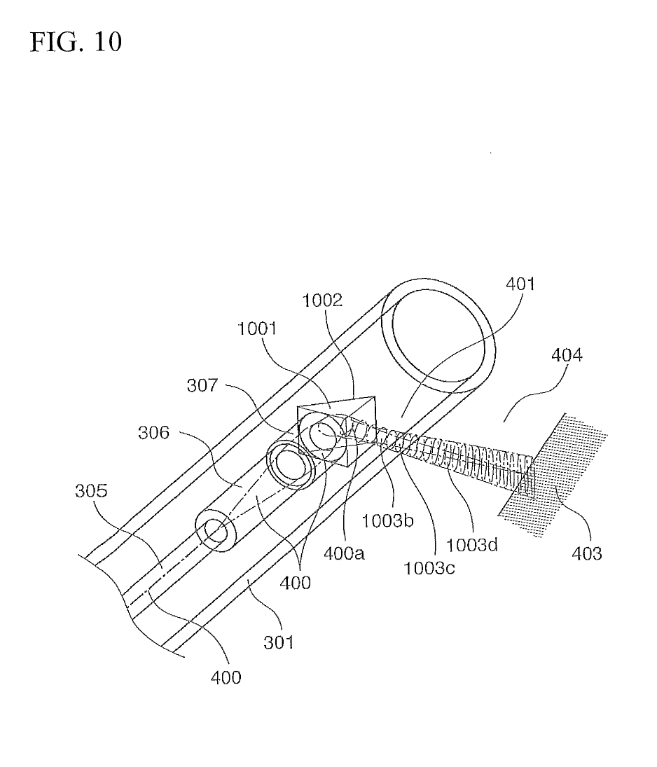

For comparison purposes or by way of reference, the ray trajectories in a first optical component having a prism, with a reflecting surface formed as a plain surface, are shown in FIG. 10.

FIG. 10 illustrates in perspective view the ray trajectories where a light beam is radiated through a catheter sheath onto a living body tissue through use of a prism with a reflecting surface formed as a plane surface.

As illustrated, the light beam 400a exiting the end portion of an optical fiber 304 is diverged by a spacer 306 connected adjacently to the end portion of the fiber, and is converged by a SELFOC lens 307 connected to the spacer 306, before being totally reflected by the reflecting surface 1002 of the prism 1001.

Here, the light beam 1003b exiting the prism 1001 is refracted at the boundary surface between the prism 1001 and air present as a medium (air) 401 in the catheter sheath 301, and is converged in the state of having an enlarged NA, before being propagated in the air 401. Upon being incident on the catheter sheath 301, the light beam 1003b becomes a light beam 1003c, which is diverged in the azimuthal direction of the catheter sheath 301 due to the refracting effect of the curved surface of the catheter sheath 301, while being not corrected in the drive axis direction of the light beam 1003c. Accordingly, a state of astigmatism results.

Further, upon being incident on the medium (physiological saline) 404 present outside the catheter sheath 301 from the catheter sheath 301, the light beam 1003c becomes a light beam 1003d, which is slightly refracted at the boundary surface between the catheter sheath 301 and the physiological saline 404. Consequently, the NA in the azimuthal direction of the catheter sheath 301 is somewhat reduced, but the light beam 1003d propagated in the medium (physiological saline) 404 outside the catheter sheath 301 maintains its astigmatism.

Thus, in the prism 1001 having the construction shown in FIG. 10, the light beam exiting the first optical component 305 of the drive shaft 105 comes to have a beam sectional shape asymmetric in the drive axis direction and the azimuthal direction, and is therefore diverged in the azimuthal direction, at the time of passing through the catheter sheath. As a result, the resolution in the azimuthal direction is lowered.

### 5. Forming Method for Realizing Configuration of First Optical Component

One method for forming the convex surface constituting the reflecting surface 601 of the prism 308 involves the ordinarily used method of grinding an optical component. Specifically, a method is preferable in which a miniature right-angled prism blanked by cutting is held by a micro-chuck or fixed with a wax, and, keeping the prism in reciprocal rotation in an uniaxial direction with the surface to be polished of the prism 308 as a center of rotation, the surface to be polished is pressed against an abrasive sheet rotated at a uniform speed.

Another forming method involves preliminarily producing a mold corresponding to a designed prism shape, with the prism then being formed by molding. As for the sizes, lens specifications, and the curved surface shape of the first optical component 305, optical characteristics of the light beam must be optimized for the intended optical coherence imaging diagnosis by optical design beforehand. The cross-sectional shape of the curved surface of the prism 308 may be a circle, an ellipse, or any other curved line shape.

As is clear from the above description, the catheter device 101 according to this disclosed embodiment includes a reflecting surface 601 of the prism 308 formed as a convex surface facing outwards in the azimuthal direction so that the light beam 400 deflected in a perpendicular direction by the prism 308 is corrected to realize different coefficients of convergence (or coefficients of divergence) and is converged more in the azimuthal direction than in the drive axis direction. This makes it possible to compensate for the spreading (diverging) of the light beam 400 in the azimuthal direction due to the inherently present concave lens effect of the catheter sheath 301.

As a result, the light beam 400 having passed through the catheter sheath 301 has a circular cross-sectional shape which is axisymmetric (inclusive of substantially axisymmetric as described above), whereby the resolution in the azimuthal direction of the sectional image is enhanced. The term axisymmetric refers to the circular light beam exiting the sheath 301 being circularly shaped in a manner that is symmetric with respect to the axis of the light beam exiting the sheath 301.

### Second Embodiment

The reflecting surface 601 of the prism 308 in the first optical component 305 is a convex surface facing outwards in the azimuthal direction in order to cancel the concave lens effect of the catheter sheath 301 in the above-described first embodiment. However, the disclosure here is not particularly limited to or by this configuration. For example, an outgoing surface of the prism 308 may be formed as a convex surface facing outwards in the azimuthal direction.

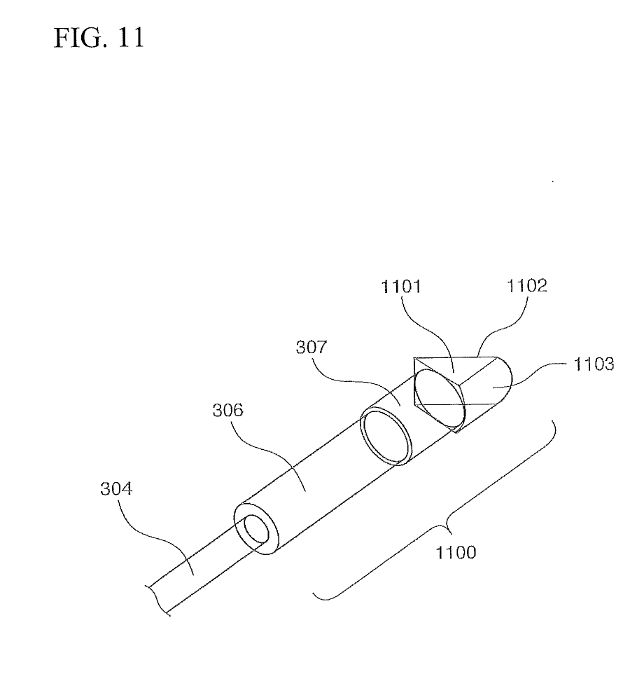

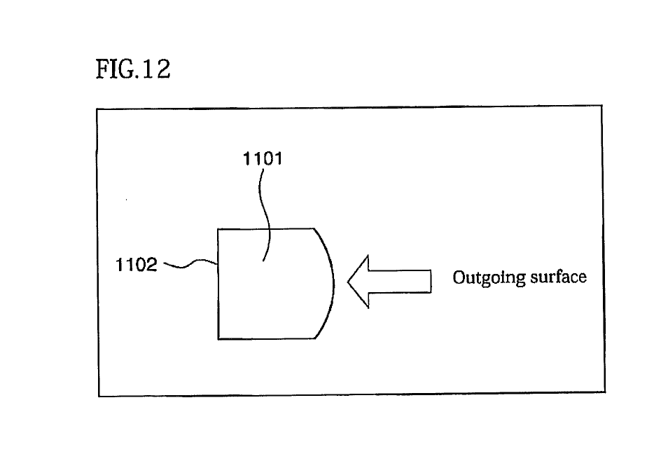

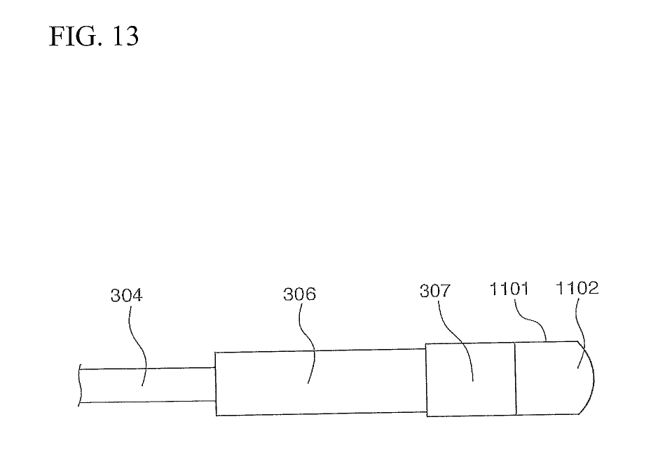

FIGS. 11-13 illustrate parts of a first optical component 1100 of a catheter device according to this embodiment.

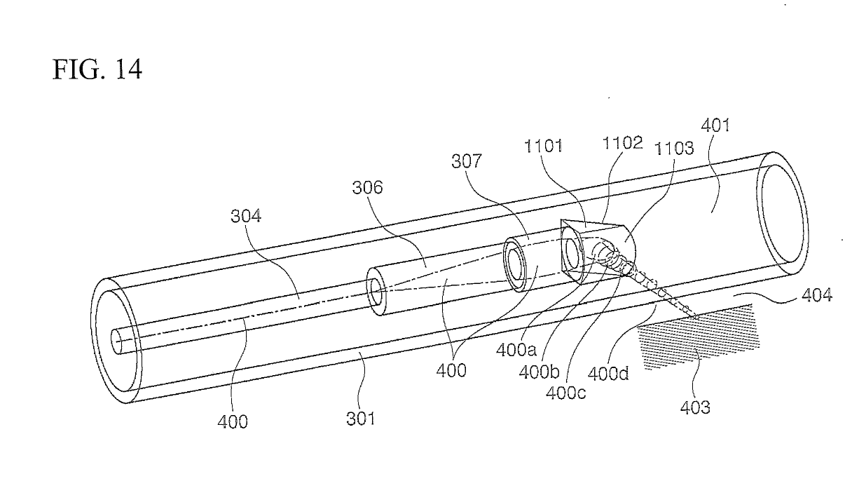

As shown in FIGS. 11-13, in the first optical component 1100, a prism (deflector) 1101 includes a reflecting or deflecting surface 1102 for a light beam that is a flat surface, whereas an outgoing surface 1103 for the light beam is formed as a convex surface facing outwards in the azimuthal direction. The outgoing surface 1103 of the prism refers to the surface of the prism through which the light beam passes immediately before entering the medium (air) 401 (shown in FIG. 14).

Further, FIG. 14 is a partly transmissive perspective view showing three-dimensionally the ray trajectories in the case where a light beam 400 guided into the optical fiber 304 is radiated at a living body tissue 403 through a catheter sheath 301.

As shown in the figure, the light beam 400 emitted from an end portion of the optical fiber 304 is diverged by a spacer 306 connected (directly connected) to the end portion of the optical fiber, is then converged in the azimuthal direction and the drive axis direction by a SELFOC lens 307 connected (directly connected) to the spacer 306, and is thereafter totally reflected by the flat reflecting surface 1102 of the prism 1101.

Then, the light beam 400a propagated in the prism 1101 is converged further in the azimuthal direction by virtue of the convex surface constituting the outgoing surface 1103 of the prism 1101, to result in a light beam 400b having an elliptical cross-sectional shape with a major diameter in the drive axis direction, before being emitted from the outgoing surface 1103 of the prism 1101. Thereafter, the light beam 400b in air 401 is converged in the state of having an NA enlarged in the azimuthal direction of the catheter sheath 301, and is propagated with its elliptical cross-sectional shape maintained.

Upon being incident on the catheter sheath 301, the light beam 400b becomes a light beam 400c, which is corrected by the concave lens effect of the catheter sheath 301 so that the NA is reduced in the azimuthal direction of the catheter sheath 301.

Further, upon being incident on a medium (physiological saline) 404 present outside the catheter sheath 301 from the catheter sheath 301, the light beam 400c becomes a light beam 400d, which is reduced in NA by refraction at the boundary surface between the catheter sheath 301 and the physiological saline 404. This results in that the difference between the NA in the azimuthal direction of the catheter sheath 301 and the NA in the drive axis direction is reduced (the NA values become approximately equal), and the cross-sectional shape of the light beam 400d is a axisymmetric circle (inclusive of a light beam having a circular cross-section that is substantially axisymmetric as discussed above). By virtue of this, the beam waist size is reduced, and the resolution in the azimuthal direction of the cross-sectional image is enhanced. When the light transmitted in the optical fiber 304 is emitted from the optical component 1101 for being radiated toward the living body tissue through the sheath 301, the optical component 1101, including the surface 1103, provides means for correcting the light on an optical path of the light so that a difference in coefficient of convergence or coefficient of divergence is generated between the drive axis direction of the drive shaft and the azimuthal direction around the drive axis direction of the drive shaft so that the difference between the diameter of the radiated light in the drive axis direction and the diameter of the radiated light in the azimuthal direction is thereby reduced (i.e., the cross-sectional shape of the light beam 400d is a circular shape which is axisymmetrical as discussed above).

As is clear from the above description, according to the catheter device 101 in this embodiment, the outgoing surface 1103 of the prism 1101 is a convex surface facing outwards in the azimuthal direction so that the light beam 400 deflected into a perpendicular direction by the prism 1101 is converged at a further higher coefficient of divergence in the azimuthal direction. This configuration makes it possible to cancel the spreading (diverging) of the light beam 400 in the azimuthal direction due to the curved surface of the catheter sheath 301.

As a result, the light beam 400 having passed through the catheter sheath 301 has a circular cross-sectional shape which is axisymmetric, whereby the resolution in the azimuthal direction of the sectional image is enhanced.

In the first and second embodiments described above, the first optical component is configured such that the first optical component reflects (deflects) the light beam at a right angle (inclusive of a substantially right angle) and, in this connection, the angle of the prism is assumed to be about 45°, for simplicity of description. When the light beam is deflected exactly at a right angle, however, reflection noises from the inside surface of the catheter sheath are generated, which causes an increase in Signal to Noise Ratio.

Therefore, the light beam deflected to a lateral side is desirably oriented in a direction slightly inclined toward the distal end side of the catheter sheath. In this case, a preferable angle of elevation of the prism is 39 to 42°. Meanwhile, the reflecting surface of the prism may be coated with aluminum or gold or the like, for rendering the reflecting surface a total reflection mirror. In the optical coherence tomography apparatus in this embodiment, however, use of light with a wavelength of 1310 nm helps ensure that any light with a reflection angle of less than 43° is totally reflected at the interface between the prism and air, since the critical angle at the interface of the optical material (glass) and air is 43°. Therefore, the reflecting surface may not necessarily be coated, in the case where light with such a wavelength is used as measurement light.

### Third Embodiment

The catheter device including the first optical component has been described above in connection with the first and second embodiments, though the device is not limited in this respect. In a catheter device including a second optical component, similarly the resolution in the azimuthal direction of the cross-sectional image can be enhanced.

### 1. General Configuration of Second Optical Component and Light Beam Ray Trajectories

A general configuration of the second optical component in the catheter device according to this embodiment and the ray trajectories in the process up to the emission of a light beam through the second optical component are described below.

### 1.1 General Configuration of Second Optical Component

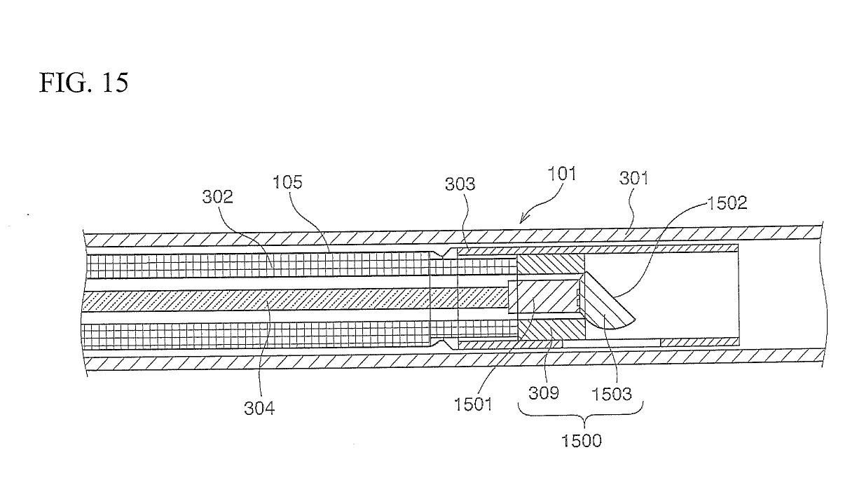

FIG. 15 illustrates as a cross-sectional view in a sideways direction a distal part of a drive shaft 105 at a distal portion of the catheter device 101. FIG. 15 shows that the distal portion of the catheter device 101 has a configuration in which the drive shaft 105 is positioned in a catheter sheath 301, and an optical fiber 304 is positioned inside of the drive shaft 105.

The drive shaft 105 includes a coil shaft 302 of a multilayer contiguous-wound coil structure, and a housing 303 fixed to the distal end side of the coil shaft 302. The second optical component 1500 for diverging a light beam, deflecting the diverged light beam in a perpendicular direction, and then converging the deflected light beam is attached to the distal portion of the optical fiber 304.

The second optical component 1500 includes a spacer 1501, and a ball lens (deflector) 1503 having an inclined surface 1502. A radiopaque marker 309 is provided in the vicinity of the distal part of the drive shaft 105. The radiopaque marker 309 serves as a means for confirming the position of the distal part of the drive shaft 105, for example under radioscopic observation.

The second optical component 1500 can be formed through optical fiber splicing by use of an optical fiber splicing machine, heat processing and such further steps as grinding and polishing.

### 1.2 Ray Trajectories

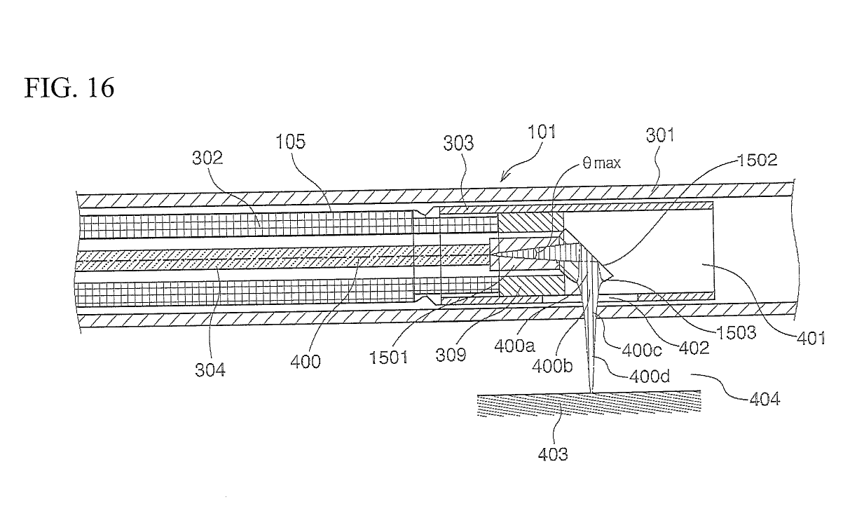

FIG. 16 schematically illustrates the ray trajectories in the case where a light beam is transmitted in the optical fiber 304 in FIG. 15. The light beam 400 is transmitted while undergoing total reflection at the boundary surface between a core part and a clad (cladding) part of the optical fiber 304. The light beam 400 having reached the distal portion of the optical fiber 304 is diverged in the spacer 1501 connected (directly connected) to the distal portion, to result in a light beam 400a. In this instance, the spreading (diverging) angle θ max of the light beam 400a in the spacer 1501 can be obtained by the above-described Equation 2.

The light beam 400a is totally reflected at the inclined surface 1502 formed at the distal portion of the spacer 1501, and is then converged by the ball lens 1503 formed at an end portion of the spacer 1501, to result in a light beam 400b which passes through an opening 402 in the housing 303.

The light beam 400b which has passed through the opening 402 of the housing 303 is refracted at the boundary surface between a medium (air) 401 and the catheter sheath 301, to result in a light beam 400c. Further, the light beam 400c is refracted at the boundary surface between the catheter sheath 301 and a medium (physiological saline) 404, to result in a light beam 400d which passes through the medium 404 before being radiated onto living body tissue 403 such as a blood vessel or the like.

In the optical design of the ball lens 1503 in the divergence-convergence optical system, the distance from the surface of the ball lens 1503 to the beam waist (working distance) and the beam waist size can be obtained by an exclusive-use optical software while using such parameters as the length of the spacer 1501, the size of the ball lens 1503, the refractive indices of the parts constituting the second optical component 1500, and the refractive index of the medium through which the light beam emitted from the second optical component passes.

Furthermore, a confocal parameter 2b representing the largeness of the region of the beam waist can be calculated by the following formula (Equation 3) while using the beam waist diameter d0 and the light beam center wavelength λ.

2b=π(d₀)²/2λ [Equation 3]

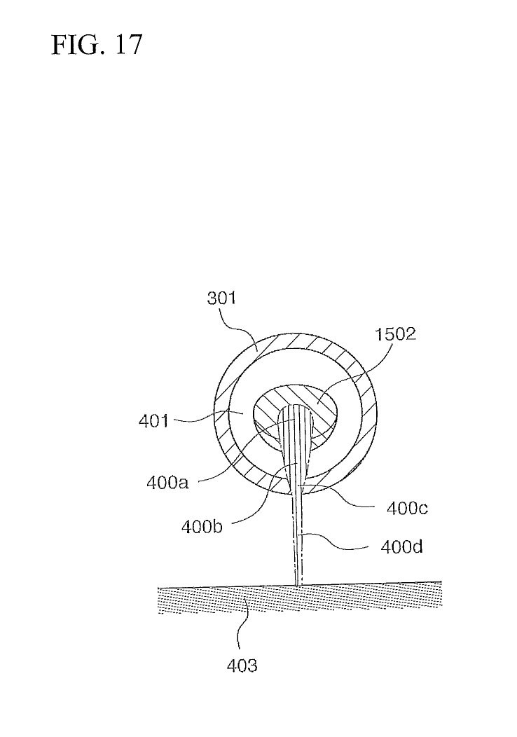

FIG. 17 illustrates a distal portion of the catheter device 101 as viewed from the distal end side in FIG. 16 and schematically shows the ray trajectories of the light beam. As illustrated in FIG. 17, the light beam 400a propagated while being diverged in the spacer 1501 is totally reflected by the inclined surface 1502 formed at the distal portion of the spacer 1501, and is then converged in the azimuthal direction and the drive axis direction by the ball lens 1503 formed at the end portion of the spacer 1501, to result in a light beam 400b.

Thereafter, the light beam 400b is largely refracted at the boundary surface of air 401 and the catheter sheath 301 which is a medium possessing a considerably higher refractive index than the air 401, to form a light beam 400c. The light beam 400c is slightly refracted at the boundary surface between the catheter sheath 301 and the physiological saline 404, which is a medium present outside the catheter sheath 301, to result in a light beam 400d having a somewhat reduced NA, which is radiated onto the living body tissue 403 of a blood vessel or the like.

### 2. Configuration of Second Optical Component

The parts of the second optical component 1500 having the above-mentioned configuration will be described in more detail below.

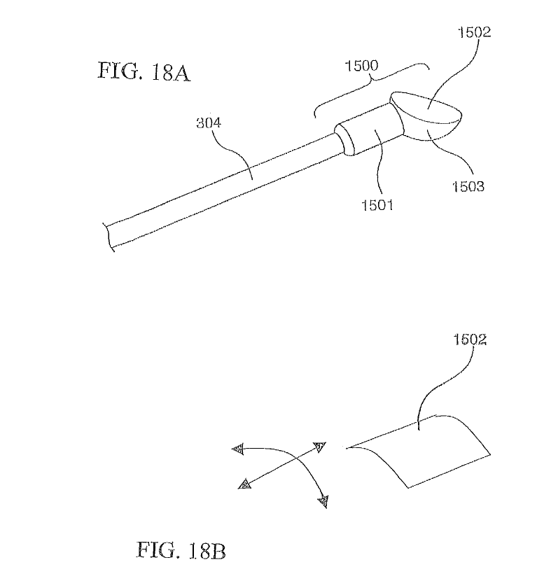

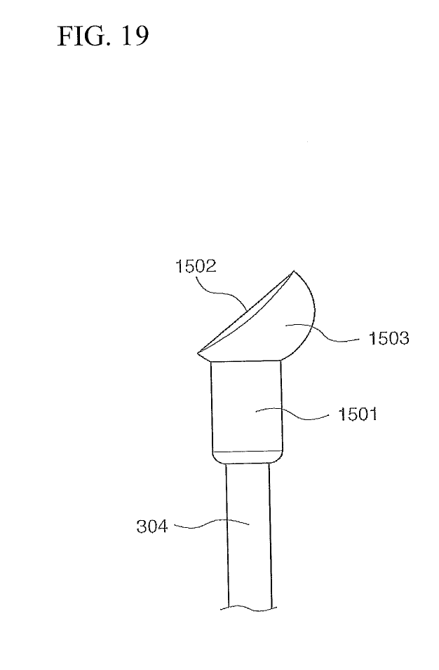

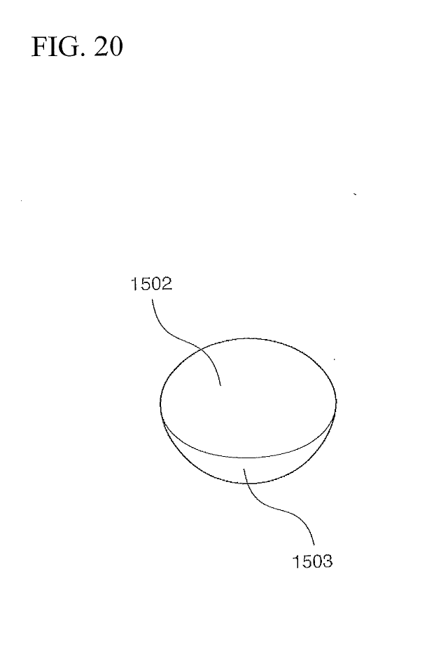

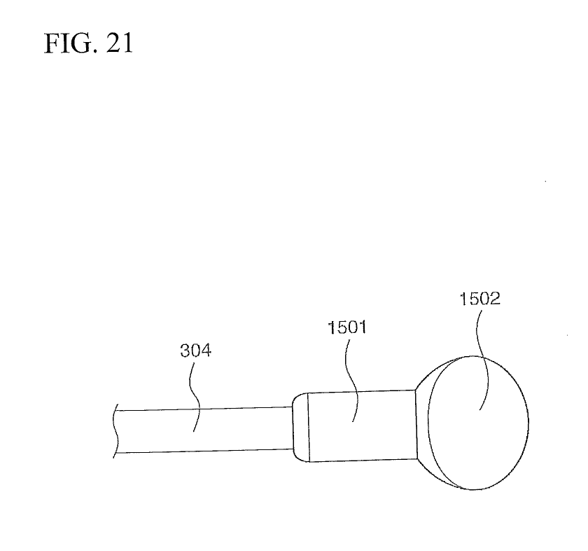

FIG. 18 illustrates the overall second optical component 1500, FIG. 19 illustrates in plan view a distal portion of the optical fiber 304 as viewed from the side, FIG. 20 illustrates the distal portion of the optical fiber 304 as viewed from the distal end side, and FIG. 21 illustrates the distal portion of the optical fiber 304 as seen from the upper side.

FIGS. 18-21 illustrate that the ball lens 1503 of the second optical component 1500 has a configuration in which the inclined surface 1502 for deflecting the light beam in a perpendicular direction is formed as a convex surface facing outwards in the azimuthal direction.

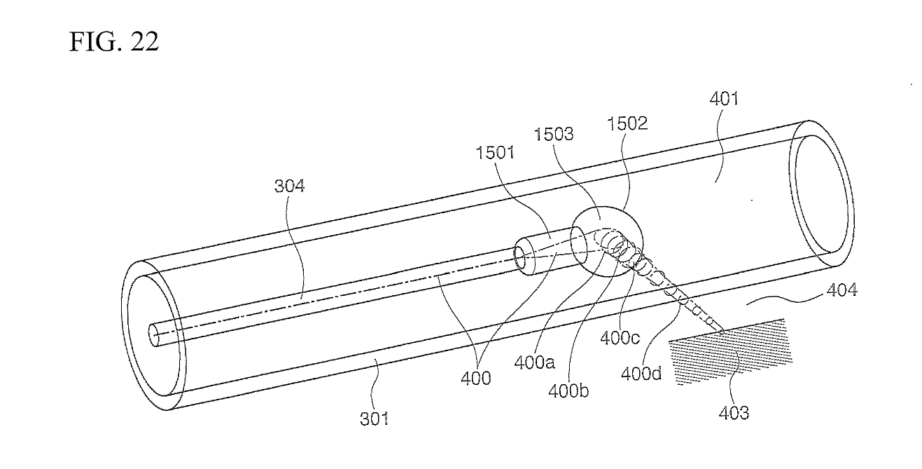

FIG. 22 illustrates a distal end portion of the catheter sheath 301, in a partly transmissive perspective view, showing the ray trajectories in the case where the light beam 400 guided into the optical fiber 304 is radiated toward the living body tissue 403 through the catheter sheath 301.

As shown, the light beam 400 having reached a distal portion of the optical fiber 304 is diverged in the spacer 1501 which is connected (directly connected) to the distal portion of the optical fiber, and then undergoes total reflection at the inclined surface 1502 formed as a convex shape, with an inner reflecting surface that is formed as a concave mirror or a concave mirrored surface, at the distal portion of the spacer 1501.

In this case, by virtue of the inclined surface 1502 formed as a convex surface (inner reflecting surface is formed as a concave mirror or is a concave mirrored surface), the light beam 400a in the spacer 1501 is converged in the azimuthal direction of the catheter sheath 301, and the cross-sectional shape of the light beam becomes an elliptic shape having a major diameter in the drive axis direction.

The light beam 400a in the spacer 1501 is refracted at the boundary surface between the ball lens 1503 formed at an end part of the spacer 1501 and air as a medium (air) 401 present inside the catheter sheath 301, and is converged in the azimuthal direction and the drive axis direction, to result in the light beam 400b.

Upon being incident on the catheter sheath 301 from the medium (air) 401 present inside the catheter sheath 301, the light beam 400b becomes a light beam 400c. The light beam 400c is corrected so that the NA is reduced in the azimuthal direction of the catheter sheath 301 by the convex lens effect of the catheter sheath 301.

Further, upon being incident on a medium (physiological saline) 404 present outside the catheter sheath 301 from the catheter sheath 301, the light beam 400c becomes a light beam 400d, while the NA is reduced by the refraction at the boundary surface. As a result, the difference between the NA in the azimuthal direction of the catheter sheath 301 and the NA in the drive axis direction is reduced (the NA values become approximately equal), and the cross-sectional shape of the light beam 400d is a circular shape which is axisymmetrical (inclusive of substantially axisymmetric as discussed above). By virtue of this, the beam waist size is reduced, and the resolution in the azimuthal direction of the cross-sectional image is enhanced. When the light transmitted in the optical fiber 304 is emitted from the optical component 1500 for being radiated toward the living body tissue through the sheath 301, the optical component 1500, including the surface 1502, provides means for correcting the light on an optical path of the light so that a difference in coefficient of convergence or coefficient of divergence is generated between the drive axis direction of the drive shaft and the azimuthal direction around the drive axis direction of the drive shaft so that the difference between the diameter of the radiated light in the drive axis direction and the diameter of the radiated light in the azimuthal direction is thereby reduced (i.e., the cross-sectional shape of the light beam 400d is a circular shape which is axisymmetrical as discussed above).

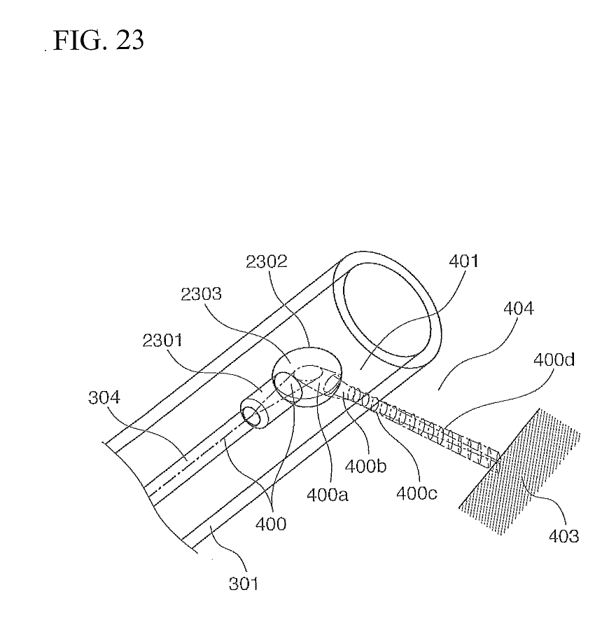

For comparison purposes, or by way of reference, FIG. 23 illustrates the ray trajectories which would result from a second optical component having a configuration as shown.

FIG. 23 illustrates the distal end portion of a catheter device, in a transmissive perspective view, and the ray trajectories that result where a light beam is radiated onto a living body tissue through a catheter sheath that includes a ball lens as illustrated.

As shown in FIG. 23, the light beam 400a emitted from an end part of an optical fiber 304 is diverged in a spacer 2301 connected to the end part, is totally reflected at an inclined surface 2302 formed at a distal portion of the spacer 2301, and is then converged by the ball lens 2303 formed at an end part of the spacer 2301, to form a light beam 400b with a large NA value.

The light beam 400b is refracted at the boundary surface between the ball lens 2303 and air as a medium (air) 401 present inside a catheter sheath 301, is converged in the state of having an enlarged NA, and is propagated in the air 401. Upon being incident on the catheter sheath 301, the light beam 400b becomes a light beam 400c. Due to refraction by the curved surface of the catheter sheath 301, the light beam 400c is put into the state of astigmatism in which it is diverged in the azimuthal direction of the catheter sheath 301, although it is converged in the drive axis direction.

Further, upon being incident on a medium (physiological saline) 404 present outside the catheter sheath 301 from the catheter sheath 301, the light beam 400c becomes a light beam 400d. Though slight refraction occurs at the boundary surface between the catheter sheath 301 and water 404 and the NA in the azimuthal direction of the catheter sheath 301 is somewhat reduced, the light beam 400d propagated in the medium 404 present outside the catheter sheath 301 maintains the astigmatism.

Thus, in the ball lens 2303 having a flat inclined surface according to the configuration shown in FIG. 23, the light beam emitted from the second optical component of a drive shaft 105 possesses a beam cross-sectional shape asymmetric in the drive axis direction and the azimuthal direction at the time when it passes through the catheter sheath, and it is diverged in the azimuthal direction. Consequently, the resolution in the azimuthal direction is lowered.

### 3. Forming Method for Realizing Configuration of Second Optical Component

An example of a method for forming the curved surface of the ball lens 1503 constituting the configuration of the second optical component 1500 involves the ordinarily used method based on grinding of an optical component part. Specifically, one desirable method involves holding and fixing a ball lens 1503 formed at a distal portion of an optical fiber 304 by an optical fiber splicing machine or the like. The ball lens is held and fixed by a holder for exclusive use. In the condition where the holder is fixed so as to be at an angle of about 45° relative to an abrasive sheet, the ball lens 1503 is put into reciprocal rotation in a uniaxial direction with the surface to be polished of the ball lens 1503 as a center of rotation, and, in this condition, the surface to be polished is pressed against the abrasive sheet being rotated at a uniform speed.

The size of the ball lens 1503, the length of the spacer 1501, and the shape of the convex surface have to be determined beforehand by optical design so that the optical characteristics of the light beam are optimized for the desired optical coherence imaging diagnosis. It is to be noted here that the cross-sectional shape of the convex surface may be a circle, an ellipse or other arbitrary curved line shape.

As is clear from the above description, according to the catheter device in this embodiment, the inclined surface 1502 of the ball lens 1503 is formed as a convex surface facing outwards in the azimuthal direction so that the light beam deflected by the inclined surface 1502 of the ball lens 1503 in a perpendicular direction is preliminarily converged in the azimuthal direction. This makes it possible to cancel the spreading (diverging) of the light beam in the azimuthal direction due to the concave lens effect of the catheter sheath 301.

Consequently, the light beam which has passed through the catheter sheath 301 has a circular cross-sectional shape which is substantially axisymmetric, and the resolution in the azimuthal direction of the cross-sectional image is enhanced.

### Fourth Embodiment

While the inclined surface of the ball lens is formed as a convex surface facing outwards in the azimuthal direction so as to cancel the concave lens effect of the catheter sheath in the third embodiment above, the disclosure here is not particularly limited to or by this configuration. For example, the inclined surface of the ball lens may be formed as a concave surface facing inwards in the drive axis direction.

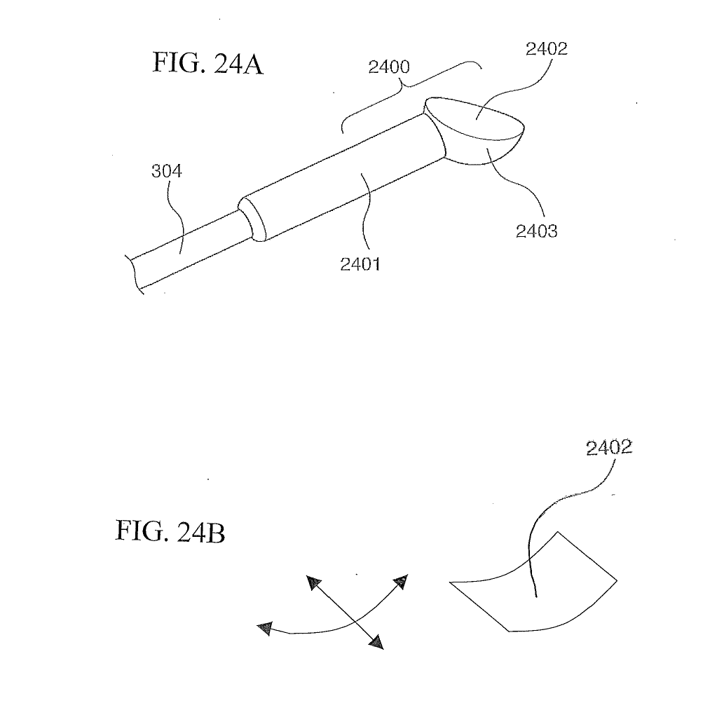

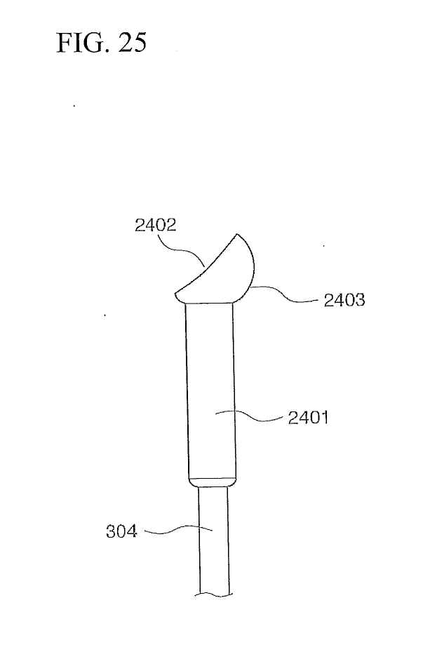

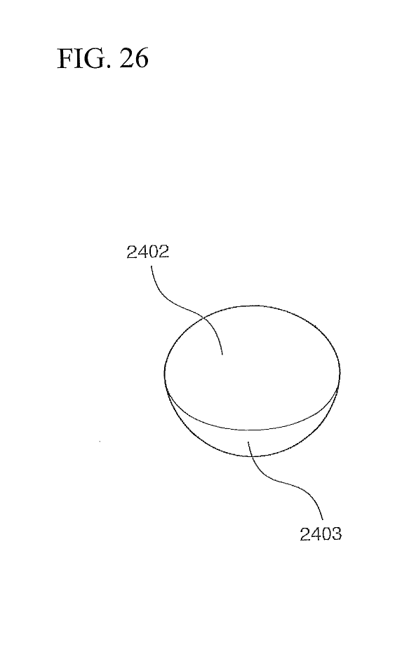

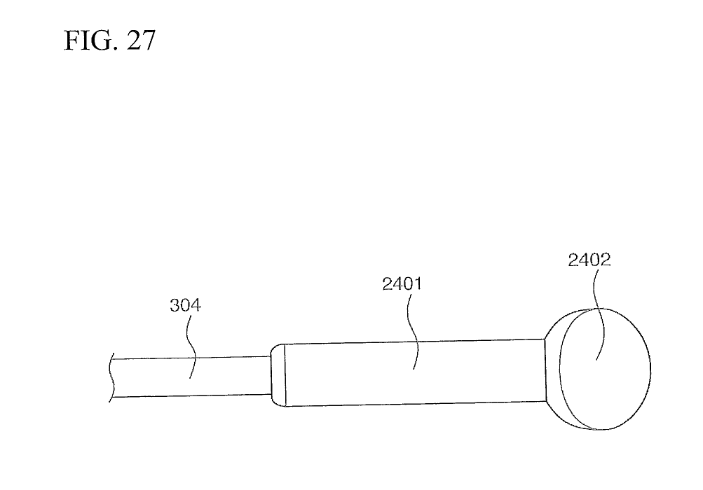

FIGS. 24-27 illustrate parts of a second optical component 2400 of a catheter device according to another embodiment.

As shown in FIGS. 24-27, the second optical component 2400 includes a ball lens (deflector) 2403 possessing an inclined surface 2402 for deflecting a light beam in a perpendicular direction which is formed as a convex surface facing inwards in the drive axis direction. In other words, the inwardly facing side of the surface 2402 which reflects the light beam is a convex surface. Further, the second optical component 2400 is configured so that the length of a spacer 2401 is sufficiently large, as compared with the spacer 1501 in the third embodiment.

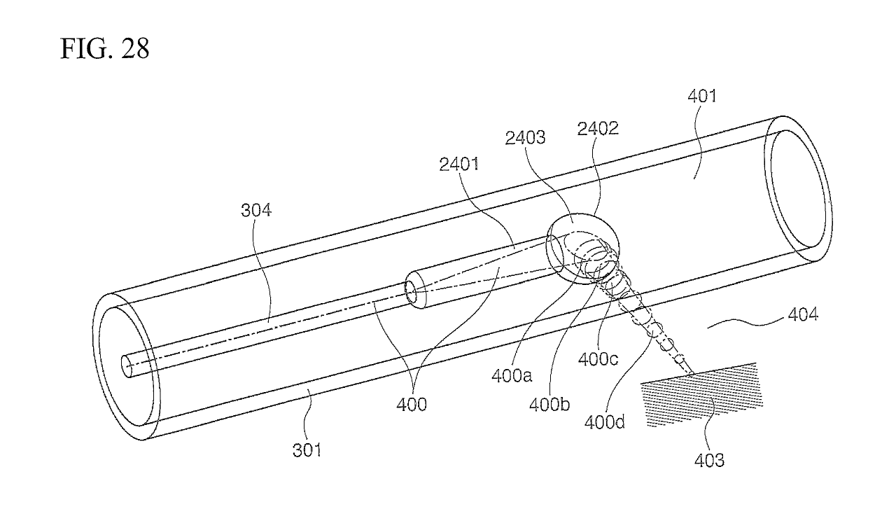

FIG. 28 illustrates the distal end portion of the catheter device, in a transmissive perspective view, and the ray trajectories that result where a light beam 400 guided into the optical fiber 304 is radiated at a living body tissue 403 through a catheter sheath 301. The light beam 400 guided into the optical fiber 304 is diverged in the spacer 2401 connected to the optical fiber 304, and undergoes total reflection at the inclined surface 2402 formed as a concave surface (inner reflecting surface is formed as a convex mirror or is a convex mirrored surfaced) at the distal portion of the spacer 2401.

In this case, due to the action of the inclined surface 2402 formed as a concave surface (inner reflecting surface is formed as a convex mirror or is a convex mirrored surfaced), the light beam 400a in the spacer 2401 is put into the state of being diverged in the drive axis direction, and its sectional shape is an elliptic shape with a major diameter in the drive axis direction. In other words, the light beam 400a is corrected so that the coefficient of divergence is relatively higher in the drive axis direction.

The light beam 400a in the spacer 2401 is refracted at the boundary surface between the ball lens 2403 formed at an end part of the spacer 2401 and air as a medium 402 present in the catheter sheath 301, and is diverged to result in a light beam 400b.

Upon being incident on the catheter sheath 301 from the medium (air) 401 present inside the catheter sheath 301, the light beam 400b becomes the light beam 400c. The light beam 400c is corrected by the refraction at the curved surface of the catheter sheath 301 so that the NA in the azimuthal direction is reduced.

Further, upon being incident on a medium (physiological saline) 404 present outside the catheter sheath 301 from the catheter sheath 301, the light beam 400c becomes the light beam 400d. The light beam 400d is reduced in NA by refraction at the boundary surface. As a result, the difference between the NA in the azimuthal direction and the NA in the drive axis direction is reduced (the NA values become approximately equal), and the sectional shape of the light beam 400d is a circular shape which is substantially axisymmetric.

By virtue of this, the beam waist size is reduced, and the resolution in the azimuthal direction of the sectional image can be enhanced. When the light transmitted in the optical fiber 304 is emitted from the optical component 2400 for being radiated toward the living body tissue through the sheath 301, the optical component 2400, including the reflecting surface 2402, provides means for correcting the light on an optical path of the light so that a difference in coefficient of convergence or coefficient of divergence is generated between the drive axis direction of the drive shaft and the azimuthal direction around the drive axis direction of the drive shaft so that the difference between the diameter of the radiated light in the drive axis direction and the diameter of the radiated light in the azimuthal direction is thereby reduced (i.e., the cross-sectional shape of the light beam 400d is a circular shape which is axisymmetrical as discussed above).

In the catheter device according to this embodiment, the length of the spacer 2401 is sufficiently longer, as compared with the spacer 1501 in the third embodiment above. This is for matching the working distance on an optical design basis.

As is clear from the above description, according to the catheter device in this embodiment, the inclined surface 2402 of the ball lens 2403 is formed as a convex surface (inner reflecting surface is formed as a concave mirror or is a concave mirrored surface) facing inwards in the drive axis direction so that the light beam deflected by the inclined surface 2402 of the ball lens 2403 in a perpendicular direction is diverged in the drive axis direction. This results in the light beam undergoing spreading (diverging) in the drive axis direction equivalent or comparable to its spreading (diverging) in the azimuthal direction due to the concave lens effect of the catheter sheath 301.

Consequently, the light beam which has passed through the catheter sheath 301 has a circular cross-sectional shape which is axisymmetrical (inclusive of substantially axisymmetric as discussed above), and the resolution in the azimuthal direction of the sectional image is enhanced.

### Fifth Embodiment

The catheter devices having the first or second optical component have been described in the first to fourth embodiments above, but the disclosure here is not particularly limited to or by these configurations. A catheter device having a third optical component as described below, can also achieve enhanced resolution in the azimuthal direction of the cross-sectional image.

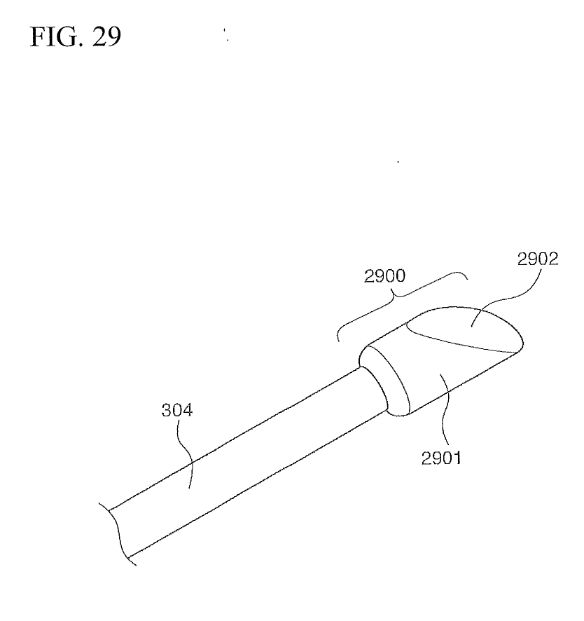

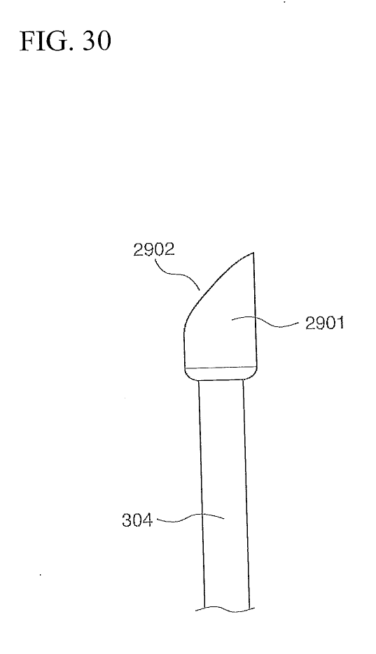

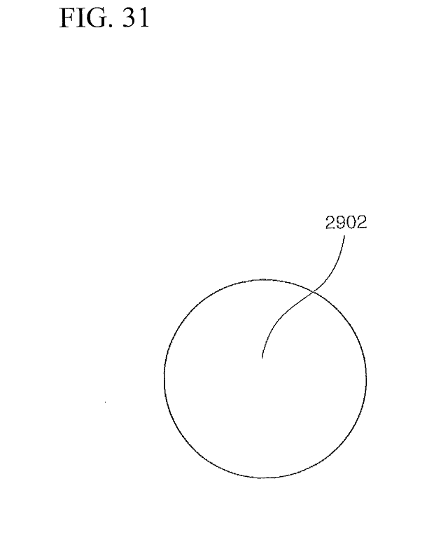

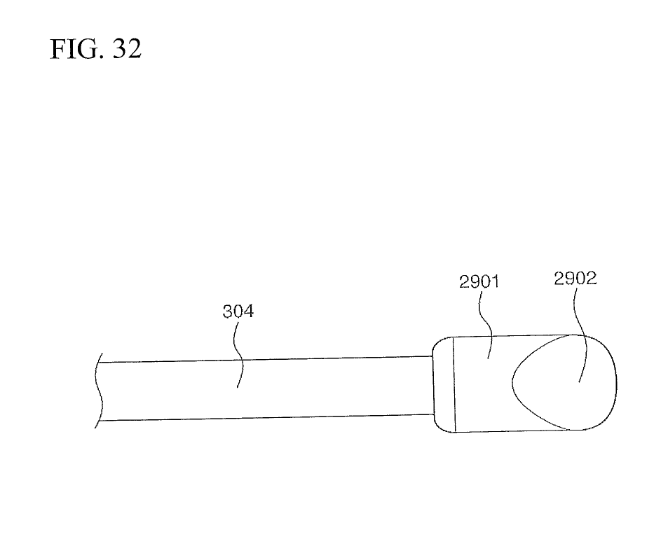

FIGS. 29-32 illustrate parts of the third optical component 2900 in the catheter device according to this embodiment.

As shown in FIGS. 29-32, the third optical component 2900 includes a spacer 2901 having an inclined surface 2902 for deflecting a light beam in a perpendicular direction. The spacer 2901 is configured such that its inclined surface 2902 is formed as a convex surface facing outwards in the drive axis direction, and its outgoing surface is formed as a convex surface facing outwards in the azimuthal direction.

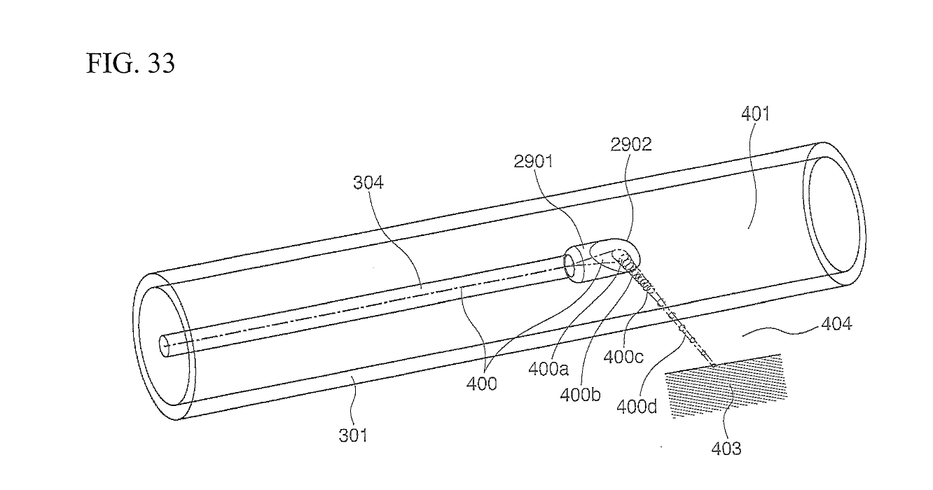

FIG. 33 illustrates the distal end portion of the catheter device, in a transmissive perspective view, and the ray trajectories that result where a light beam guided into the optical fiber 304 is radiated to a living body tissue 403 through a catheter sheath 301 in FIG. 29. The light beam 400 which has reached a distal portion of the optical fiber 304 is diverged in the spacer 2901 connected adjacently to the distal portion, and undergoes total reflection at the inclined surface 2902 formed as a convex surface at a distal portion of the spacer 2901.

In this case, by virtue of the inclined surface 2902 formed as a convex surface, a light beam 400a in the spacer 2901 is converged in the drive axis direction, and its cross-sectional shape is an elliptic shape with a major diameter in the azimuthal direction.

Since the outgoing surface of the spacer 2901 is formed as a convex surface facing outwards in the azimuthal direction, the light beam 400a in the spacer 2901 is converged in the azimuthal direction to form a light beam 400b (In this instance, the light beam 400b, on the contrary, has an elliptic sectional shape with a major diameter in the drive axis direction.).

Upon being incident on the catheter sheath 301 from a medium (air) 401 present inside the catheter sheath 301, the light beam 400b becomes a light beam 400c. The light beam 400c is corrected by the refraction at the curved surface of the catheter sheath 301 so that the NA is reduced in the azimuthal direction of the catheter sheath 301.

Further, upon being incident on a medium (physiological saline) 404 present outside the catheter sheath 301 from the catheter sheath 301, the light beam 400c becomes a light beam 400d. The light beam 400d is reduced in NA by the refraction at the boundary surface. As a result, the NA in the azimuthal direction of the catheter sheath 301 approaches the NA in the drive axis direction, so that the cross-sectional shape of the light beam 400d is a circular shape which is axisymmetric (inclusive of substantially axisymmetric as described above). By virtue of this, the beam waist size is reduced, and the resolution in the azimuthal direction of the sectional image is enhanced. When the light transmitted in the optical fiber 304 is emitted from the optical component 2900 for being radiated toward the living body tissue through the sheath 301, the optical component 2902, including the reflecting surface 2902, provides means for correcting the light on an optical path of the light so that a difference in coefficient of convergence or coefficient of divergence is generated between the drive axis direction of the drive shaft and the azimuthal direction around the drive axis direction of the drive shaft so that the difference between the diameter of the radiated light in the drive axis direction and the diameter of the radiated light in the azimuthal direction is thereby reduced (i.e., the cross-sectional shape of the light beam 400d is a circular shape which is axisymmetrical as discussed above).

In the third to fifth embodiments described above, the optical component is configured such that the second or third optical component reflects (deflects) the light beam at a right angle (inclusive of angles approximate to a right angle). In this regard, the angle of the reflecting inclined surface of the ball lens or the spacer is assumed to be about 45°, for simplicity of description. When the light beam is deflected exactly at a right angle, however, reflection noises from the inside surface of the catheter sheath are generated, which causes an increase in Signal to Noise Ratio.

Therefore, the light beam deflected to a lateral side is desirably oriented in a direction slightly inclined toward the distal end side of the catheter sheath. In this case, a preferable angle of elevation of the ball lens or spacer is 39 to 42°. Meanwhile, the reflecting surface of the ball lens or spacer may be coated with aluminum or gold or the like, for rendering the reflecting surface a total reflection mirror. In the optical coherence tomography apparatus in the embodiments, however, use of light with a wavelength of 1310 nm ensures that any light with a reflection angle of less than 43° is totally reflected at the interface between the ball lens or spacer and air, since the critical angle at the interface of the optical material (glass) and air is 43°. Therefore, the reflecting surface may not necessarily be coated, in the case where light with such a wavelength is used as measurement light.

As is clear from the above description, according to the catheter device in this embodiment, the inclined surface 2902 of the spacer 2901 is formed as a convex surface facing outwards in the drive axis direction, and the outgoing surface of the spacer 2901 is formed as a convex surface facing outwards in the azimuthal direction, whereby it is ensured that the cross-sectional shape of the light beam which has passed through the catheter sheath is a circular shape which is axisymmetrical (substantially axisymmetric as described previously). As a result, the resolution in the azimuthal direction of the cross-sectional image is enhanced. The spacer in the fifth embodiment, as well as the ball lens in the third and fourth embodiments, serve the dual functions of reflection and focusing.

In the catheter device (optical probe) in each of the first to fifth embodiments, as above-mentioned, the aspect ratio of the measurement light is corrected so that the values of the coefficient of convergence or coefficient of divergence in the drive axis direction and in the azimuthal direction are different from each other, whereby the measurement light is emitted in the state of having an elliptic cross-sectional shape. As a result of this, the influence of passage of the measurement light through the light-transmitting catheter sheath can be minimized, and a signal preferable for obtaining a cross-sectional image is obtained. In addition, in the catheter device (optical probe) in each of the first to fifth embodiments, the optical component and the distal portion of the optical fiber are integrally formed in one piece at the same time to form a unitary structure.

Specifically, as described in the embodiments above, the light is corrected so that the cross-sectional shape of the light is an elliptic shape with a major axis in the drive axis direction and with a minor axis in the azimuthal direction. Therefore, it is desirable to perform correction such that the coefficient of convergence in the azimuthal direction is raised above that (greater than) in the major axis direction, or the coefficient of divergence in the major axis direction is raised above that (greater than) in the azimuthal direction. As described above in connection with the five disclosed embodiments, when the light transmitted in the optical fiber and emitted from the optical component is radiated toward the living body tissue through the sheath, the optical component corrects the light on an optical path of the light so that a difference in coefficient of convergence or coefficient of divergence is generated between the drive axis direction of the drive shaft and the azimuthal direction around the drive axis direction of the drive shaft and so that the difference between the diameter of the radiated light in the drive axis direction and the diameter of the radiated light in the azimuthal direction is thereby reduced.

The detailed description above describes preferred embodiments of the optical probe disclosed here with reference to the accompanying drawings. However, it is to be understood that the invention is not limited to those precise embodiments described and illustrated above. Various changes, modifications and equivalents could be effected by one skilled in the art without departing from the spirit and scope of the invention as defined in the appended claims. It is expressly intended that all such changes, modifications and equivalents which fall within the scope of the claims are embraced by the claims.

1. An optical coherence tomography apparatus comprising:
a catheter device comprising a drive shaft;
a scanner and pull-back unit operatively connected to the catheter device to effect radial scanning of the drive shaft;
a controller operatively connected to the scanner and pull-back unit to control operation of the scanner and pull-back unit;
the drive shaft comprising:
an optical fiber rotatably positioned in a sheath configured to be inserted in a body cavity, the optical fiber comprising a distal portion; and
an optical component attached to the distal portion of the optical fiber and operative to emit light, transmitted in the optical fiber, through the sheath as radiated light directed toward living body tissue in the body cavity;
the optical component comprising means for correcting the light, which is transmitted in the optical fiber on an optical path, so that a difference in coefficient of convergence or coefficient of divergence is generated between a drive axis direction of the drive shaft and an azimuthal direction around the drive axis direction and so that a difference between the diameter of the radiated light in the drive axis direction and the diameter of the radiated light in the azimuthal direction is thereby reduced.

2. The optical coherence tomography apparatus according to claim 1, wherein the optical component comprises a rod lens which receives and converges the light in the optical fiber, and a prism comprising a deflecting surface which deflects the converged light produced by the rod lens at substantially a right angle, the means comprising the deflecting surface being a concave surface facing the azimuthal direction.

3. The optical coherence tomography apparatus according to claim 1, wherein the optical component comprises a rod lens which receives and converges the light in the optical fiber, and a prism comprising a deflecting surface which deflects the converged light produced by the rod lens at substantially a right angle, the prism comprising an outgoing surface though which the light deflected by the deflecting surface exits the prism, the means comprising the outgoing surface being a convex surface facing the azimuthal direction.

4. The optical coherence tomography apparatus according to claim 1, wherein the optical component comprises a ball lens which has a reflecting surface which deflects a traveling direction of the light transmitted in the optical fiber substantially at a right angle and which converges the deflected light.

5. The optical coherence tomography apparatus according to claim 4, wherein the reflecting surface is a concave surface facing the azimuthal direction.

6. The optical coherence tomography apparatus according to claim 4, wherein the reflecting surface is a convex surface facing the drive axis direction.

7. The optical coherence tomography apparatus according to claim 1, wherein the optical component comprises a spacer which diverges the light transmitted in the optical fiber and which has a reflecting surface for deflecting a traveling direction of the diverged light substantially at a right angle, said reflecting surface is a convex surface facing the drive axis direction, and an outgoing surface of the spacer from which the light deflected substantially at a right angle exits the spacer is a convex surface facing the azimuthal direction.

8. An optical probe comprising:
a drive shaft positionable in a sheath which is insertable in a body cavity;
the drive shaft being comprised of an optical fiber and an optical component attached to a distal portion of the optical fiber;
the optical component being operable to emit light, transmitted in the optical fiber along a traveling direction, through the sheath as radiated light directed toward living body tissue in the body cavity;
the optical component comprising means for correcting the light, which is transmitted in the optical fiber on an optical path, so that a difference in coefficient of convergence or coefficient of divergence is generated between a drive axis direction of the drive shaft and an azimuthal direction around the drive axis direction and so that a difference between the diameter of the radiated light in the drive axis direction and the diameter of the radiated light in the azimuthal direction is thereby reduced.

9. The optical probe according to claim 8, wherein the optical component comprises a rod lens which receives and converges the light transmitted in the optical fiber, and a prism which deflects the traveling direction of the converged light at substantially a right angle.

10. The optical probe according to claim 9, wherein a deflecting surface of the prism deflects the traveling direction of the converged light at substantially a right angle, the means comprising the defecting surface being a concave surface which faces the azimuthal direction.

11. The optical probe according to claim 9, wherein the prism comprises an outgoing surface from which the light deflected at substantially a right angle is emitted from the prism, the means comprising the outgoing surface being a convex surface facing the azimuthal direction.

12. The optical probe according to claim 1, wherein the optical component comprises a ball lens which has a reflecting surface which deflects the traveling direction of the light transmitted in the optical fiber at substantially a right angle and which converges the deflected light.

13. The optical probe according to claim 12, wherein the means comprises the reflecting surface being formed as a concave surface facing the azimuthal direction.

14. The optical probe according to claim 12, wherein the means comprises the reflecting surface being a convex surface facing the drive axis direction.

15. The optical probe according to claim 8, wherein the optical component comprises a spacer which diverges the light transmitted in the optical fiber and which has a reflecting surface which deflects the traveling direction of the diverged light at substantially a right angle, the means comprising the reflecting surface being a convex surface facing the drive axis direction and an outgoing surface of the spacer being a convex surface facing the azimuthal direction, the light deflected by the reflecting surface exiting the spacer by way of the outgoing surface.

16. The optical probe according to claim 8, wherein the optical component and the distal portion of the optical fiber are integrally formed in one piece at the same time.

17. The optical probe according to claim 8, wherein said means comprises a ground convex surface or a ground concave surface.

18. The optical probe according to claim 8, wherein said means comprises a molded convex surface or a molded concave surface.

19. An optical probe comprising:
a drive shaft positionable in a sheath which is insertable in a body cavity;
the drive shaft being comprised of an optical fiber and an optical component attached to a distal portion of the optical fiber, and the drive shaft possessing a drive axis direction;
the optical component comprising an inclined surface formed as a curved surface configured to reflect a light beam which has reached a distal portion of the optical fiber, and an outgoing surface formed as a convex surface facing outwards in an azimuthal direction around the drive axis direction;
wherein the inclined surface and the outgoing surface are configured to correct the light beam so that a difference in coefficient of convergence or coefficient of divergence is generated between the drive axis direction and the azimuthal direction and so that a difference between the diameter of the radiated light in the drive axis direction and the diameter of the radiated light in the azimuthal direction is thereby reduced.

20. The optical probe according to claim 19, wherein the optical component is an assembly comprised of a spacer which does not function to focus the light beam in the drive axis direction and a ball lens located at a distal position of the spacer.

21. The optical probe according to claim 19, wherein the optical component is a spacer which does not function to focus the light beam in the drive axis direction.
